(19) United States
(12) Patent Application Publication
(10) Pub. No.: US 2020/0242561 A1
(43) Pub. Date: Jul. 30, 2020

(54) INTERFACES TO IMPROVE MEMBER INTERACTIONS

(71) Applicant: Microsoft Technology Licensing, LLC, Redmond, WA (US)

(72) Inventors: Kedar Kulkarni, San Francisco, CA (US); Dezhen Li, San Francisco, CA (US); Jiuling Wang, Union City, CA (US)

(21) Appl. No.: 16/255,988

(22) Filed: Jan. 24, 2019

(51) Int. Cl. G06Q 10/10; G06F 9/451

(52) U.S. Cl. CPC G06Q 10/1053; G06F 9/451

(57) ABSTRACT

Apparatuses, computer readable medium, and methods are disclosed for job seeker interactions. A computer-implemented method may include determining that a member was not successful in performing a task on a connection network. The method may further include determining actions that successful members performed that were successful at the task. The method may include presenting the unsuccessful member with an interface to perform actions that the successful members performed. The method may include comparing the successful members with the unsuccessful member and suggesting tasks where the unsuccessful member may be successful. The method may include comparing the successful members with the unsuccessful member and displaying attributes of the successful members that may have contributed to their success.

### TECHNICAL FIELD

Embodiments pertain to interfaces to improve member interactions. Some embodiments relate to comparing interactions of an unsuccessful member with interactions of successful members and presenting interfaces for the unsuccessful member to perform similar actions as successful members.

### BACKGROUND

A connection network system may have hundreds of millions or even billions of members. The members may perform actions to accomplish tasks. Some members may have performed the tasks with successful outcomes and other members may have performed the tasks with unsuccessful outcomes.

### DESCRIPTION OF THE DRAWINGS

FIG. 1 is a block diagram of a connection network system, in accordance with some embodiments;

FIG. 2 illustrates different ways the connection network system interacts with a job seeker, in accordance with some embodiments;

FIG. 3 illustrates a data structure of a job posting, in accordance with some embodiments;

FIG. 4 illustrates a data structure of a company, in accordance with some embodiments;

FIG. 5 illustrates a data structure of a job seeker, in accordance with some embodiments;

FIG. 6 illustrates a data structure of a recruiter, in accordance with some embodiments;

FIG. 7 illustrates a data structure of triggering events, in accordance with some embodiments;

FIG. 8 illustrates a data structure of a member, in accordance with some embodiments;

FIG. 9 illustrates a system for job seeker interactions, in accordance with some embodiments;

FIG. 10 illustrates a User Interface (GUI) showing a triggering event where the first response time has elapsed, in accordance with some embodiments;

FIG. 11 illustrates an example GUI showing common traits of job seekers who heard back, in accordance with some embodiments;

FIG. 12 illustrates an example GUI displaying suggested jobs, in accordance with some embodiments;

FIG. 13 illustrates an example of a GUI displaying an application reminder, in accordance with some embodiments;

FIG. 14 illustrates a GUI showing application suggestions, in accordance with some embodiments;

FIG. 15 illustrates a GUI showing application suggestions, in accordance with some embodiments;

FIG. 16 illustrates a GUI for a job seeker, in accordance with some embodiments;

FIG. 17 illustrates a GUI for a job poster, in accordance with some embodiments;

FIG. 18 illustrates a system to determine whether to display a request, in accordance with some embodiments;

FIG. 19 illustrates a method for improving member user interaction, in accordance with some embodiments;

FIG. 20 illustrates a method for improving member user interaction, in accordance with some embodiments; and

FIG. 21 shows a diagrammatic representation of the machine in the example form of a computer system and within which instructions (e.g., software) for causing the machine to perform any one or more of the methodologies discussed herein may be executed.

### DETAILED DESCRIPTION

The present disclosure describes methods, systems and computer program products for interfaces to improve member interactions. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations permutations and combinations of the various features and elements described herein.

A method, system, and computer readable media are disclosed that may improve the interactions of unsuccessful job applicants by comparing the unsuccessful members with successful members. In some embodiments, the successful job applicants may have received an interaction for a job that they applied for and the unsuccessful job applicant may not have received an interaction. The interaction may be a contact from someone associated with the job, e.g., a view of the member's profile or a message from a recruiter. The unsuccessful job applicant is provided an interface to perform actions that the successful job applicant performed, e.g., messaging a person at the company that is offering the job. The unsuccessful job applicant is also provided with information regarding the characteristics of successful job applicants and may be provided with alternative jobs that may be more suitable for the unsuccessful job applicant.

Previously, unsuccessful job applicants applied for a job and did not receive feedback as to why they were unsuccessful. The unsuccessful candidate was provided with no feedback as to why some job applicants were selected to proceed to the next level and they were not. The unsuccessful job applicant was left in a position of not knowing how to improve their chances of successfully getting a new job. The interfaces disclosed herein improve on prior solutions by providing feedback to the unsuccessful job applicant so that the unsuccessful job applicant may determine the characteristics or attributes of successful job applicants and they can improve their chances of being contacted for the current job or future jobs. The unsuccessful job applicants may improve their chances of being successful job applications by using the interfaces for applying to jobs provided by the connection network system. The unsuccessful job applicants and the successful job applicants may be members of a connection network.

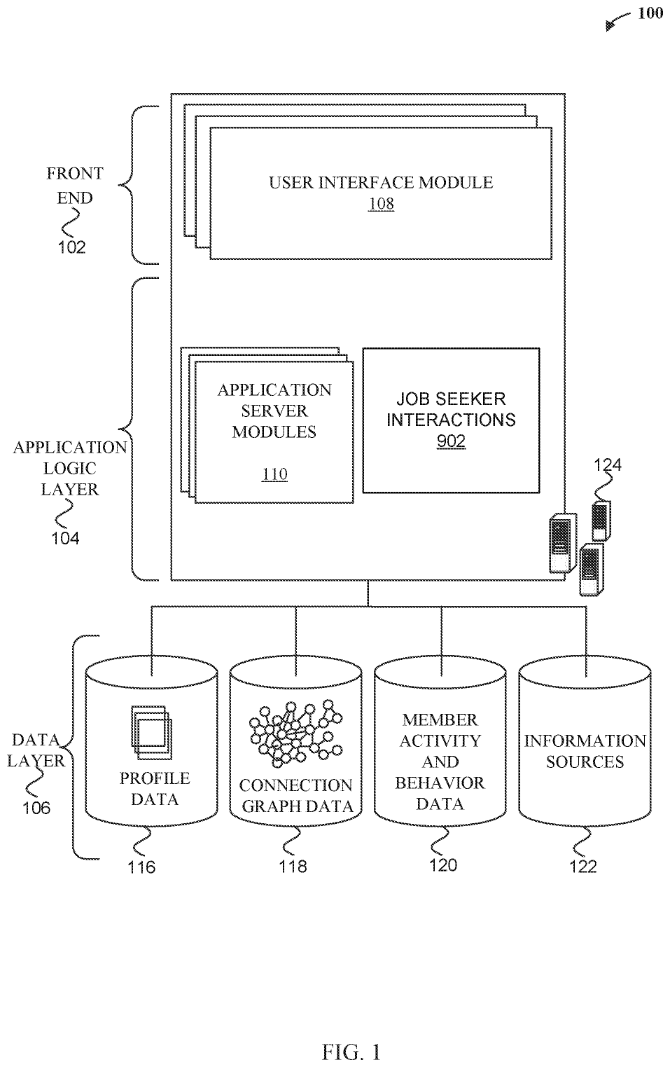

FIG. 1 is a block diagram of a connection network system 100, in accordance with some embodiments. The connection network system 100 may be based on a three-tiered architecture, comprising a front-end layer 102, application logic layer 104, and data layer 106. Some embodiments implement the connection network system 100 using different architectures. The connection network system 100 may be implemented on one or more computers 124. The computers 124 may be servers, personal computers, laptops, portable devices, etc. The computers 124 may be distributed across a network. The connection network system 100 may be implemented in a combination of software, hardware, and firmware.

As shown in FIG. 1, the front end 102 includes user interface modules 108. The user interface modules 108 may be one or more web services. The user interface modules 108 receive requests from various client-computing devices, and communicate appropriate responses to the requesting client devices. For example, the user interface modules 108 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems.

As shown in FIG. 1, the data layer 106 includes profile data 116, connection graph data 118, member activity and behaviour data 120, and information sources 122. Profile data 116, connection graph data 118, and member activity and behavior data 120, and/or information sources 122 may be databases. One or more of the data layer 106 may store data relating to various entities represented in a connection graph. In some embodiments, these entities include members, companies, and/or educational institutions, among possible others. Consistent with some embodiments, when a person initially registers to become a member of the connection network system 100, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current position title, position description, industry, employment history, skills, professional organizations, and so on. This information is stored as part of a member's member profile (e.g., 804), for example, in profile data 116. The profile data 116 may include the member 802 data structure.

With some embodiments, a member's profile data will include not only include the explicitly provided data, but also any number of derived or computed member profile attributes and/or characteristic, which may become part of one of more of profile data 116, connection graph data 118, member activity and behaviour data 120, and/or information sources 122.

Once registered, a member may invite other members, or be invited by other members, to connect via the connection network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the connection graph data 118. With some embodiments the connection graph data 118 may be implemented with a graph database, which is a particular type of database that uses graph structures with nodes, edges, and properties to represent and store data. In this case, the connection graph data 118 reflects the various entities that are part of the connection graph, as well as how those entities are related with one another.

With various alternative embodiments, any number of other entities might be included in the connection graph data 118, and as such, various other databases may be used to store data corresponding with other entities. For example, although not shown in FIG. 1, consistent with some embodiments, the system may include additional databases for storing information relating to a wide variety of entities, such as information concerning various online or offline people, position announcements, companies, groups, posts, job posts, slide shares, and so forth.

With some embodiments, the application server modules 110 may include one or more activity and/or event tracking modules, which generally detect various user-related activities and/or events, and then store information relating to those activities/events in, for example, member activity and behaviour data 120. For example, the tracking modules may identify when a user makes a change to some attribute of his or her member profile, or adds a new attribute and may trigger job seeker interactions 902. Additionally, a tracking module may detect the interactions that a member has with different types of content. For example, a tracking module may track a member's activity with respect to position announcements, e.g. position announcement views, saving of position announcements, applications to a position in a position announcement, explicit feedback regarding a position announcement (e.g., not interested, not looking, too junior, not qualified, information regarding the position the member would like, a location member wants to work, do not want to move, more like this, etc.), position search terms that may be entered by a member to search for position announcements.

Such information may be used, for example, by one or more recommendation engines to tailor the content presented to a particular member, and generally to tailor the user experience for a particular member. Information sources 122 may be one or more additional information sources. For example, information sources 122 may include external sources that include data bases of standards such as titles for jobs 326.

The application server modules 110, which, in conjunction with the user interface module 108, generate various user interfaces (e.g., web pages) with data retrieved from the data layer 106. In some embodiments, individual application server modules 110 are used to implement the functionality associated with various applications, services and features of the connection network service. For instance, a messaging application, such as an email application, an instant messaging application, or some hybrid or variation of the two, may be implemented with one or more application server modules 110. Of course, other applications or services may be separately embodied in their own application server modules 110. In some embodiments applications may be implemented with a combination of application service modules 110 and user interface modules 108. For example, interfaces to improve member interaction may be implemented with a combination of back-end modules, front-end modules, and modules that reside on a user's computer (not illustrated). For example, the connection network system 100 may download a module to a web browser running on a user's computer (not illustrated), which may communicate with an application server module 110 (e.g., job seeker interactions 902) running on a server 114 which may communicate with a module running on a back-end database server (not illustrated).

The connection network system 100 may provide a broad range of applications and services that allow members the opportunity to share and receive information, often customized to the interests of the member. For example, in some embodiments, the connection network system 100 may include an application (e.g., job seeker interactions 902) that provides members (e.g., 802) with GUIs (e.g., 1000-1700) that may improve the members interactions when applying for a job 326.

With some embodiments, members of a connection network service may be able to self-organize into groups, or interest groups, organized around a subject matter or topic of interest. Accordingly, the data for a group may be stored in connection graph data 118. When a member joins a group, his or her membership in the group may be reflected in the connection graph data 118. In some embodiments, members may subscribe to or join groups affiliated with one or more companies. For instance, with some embodiments, members of the connection network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the connection graph and modelled with the connection graph data 118.

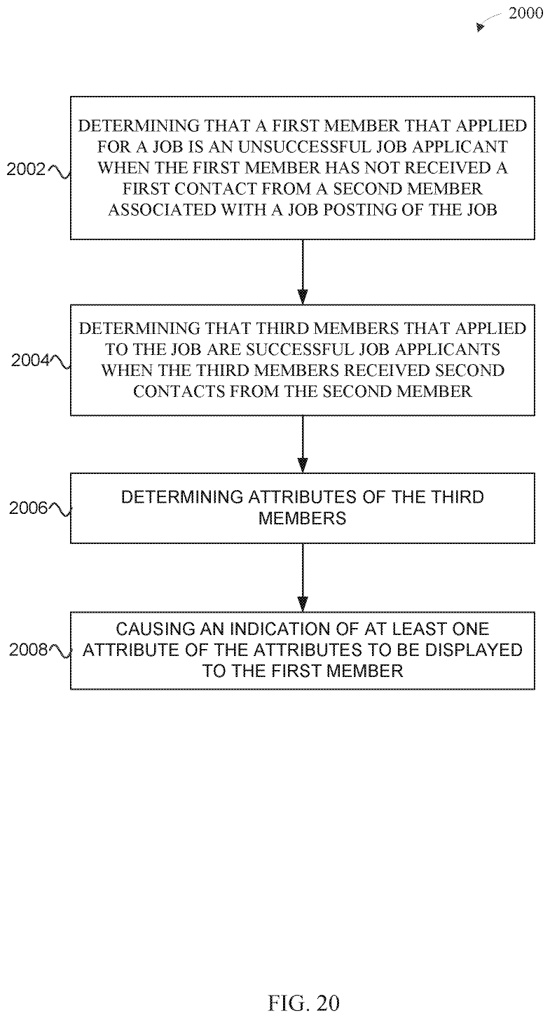

In addition to the various application server modules 110, the application logic layer 104 includes job seeker interactions 902, in accordance with some embodiments. Job seeker interactions 902 may be module or component and may be implemented as disclosed in conjunction with FIG. 20. As illustrated in FIG. 1, in some embodiments the application logic layer includes job seeker interactions 902 that may be implemented as a service that operates in conjunction with various application server modules 110 and user interface modules 108. For instance, any number of individual application server modules 110 can invoke the functionality job seeker interactions 902. However, with various alternative embodiments, job seeker interactions 902 may be implemented as an application server module 110 such that it operates as a stand-alone application.

In some embodiments, job seeker interactions 902 includes or has an associated publicly available API that enables third-party applications to invoke the functionality of job seeker interactions 902.

As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the disclosed embodiments with unnecessary detail, various functional modules and engines that are not germane to conveying an understanding of the inventive subject matter have been omitted from FIG. 1. However, a skilled artisan will readily recognize that various additional functional modules and engines may be used with a connection network system, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the disclosed embodiments are by no means limited to such architecture.

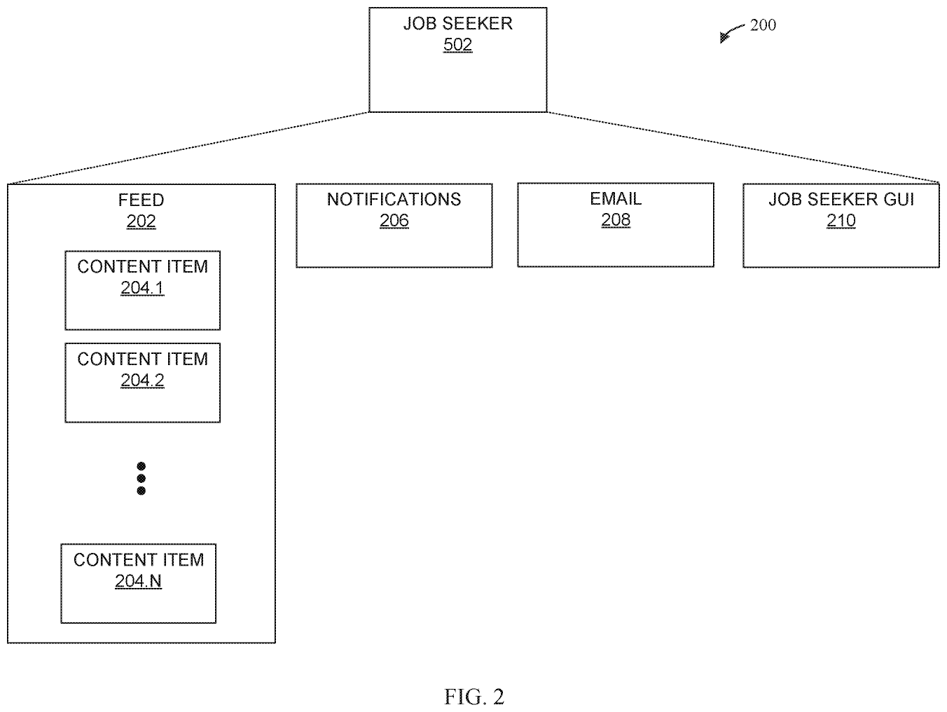

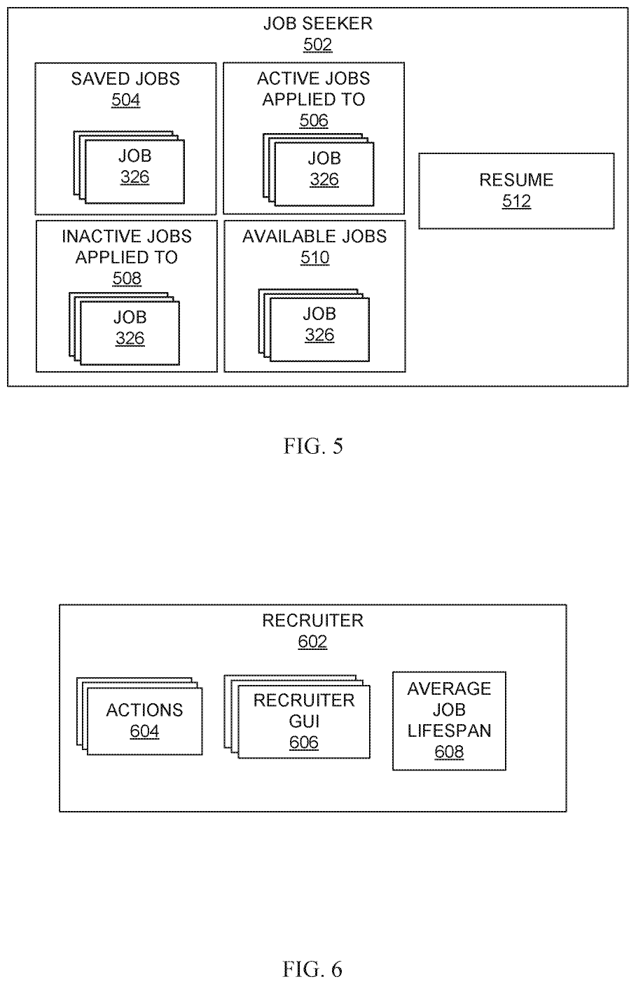

FIG. 2 illustrates different ways the connection network system interacts 200 with a job seeker 502, in accordance with some embodiments. Illustrated in FIG. 2 is job seeker 502, feed 202, notifications 206, email 208, and job seeker GUI 210. The feed 202 may be a feed of job seeker 502. The job seeker 502 may be the same or similar as job seeker 502 disclosed in conjunction with FIG. 5. The feed 202 may be a place where content items 204 may be displayed to the job seeker 502, e.g., a screen of a laptop, smart phone, tablet, or other device. The feed 202 may display content items 204.1, 204.2, through 204.N. The content items 204 may be interfaces and/or messages as disclosed in conjunction herein, e.g., in conjunction with FIGS. 1-21.

Notifications 206 may include notifications such as messages and/or notifications related to an interface as disclosed herein, e.g., in conjunction with FIGS. 1-21. In some embodiments, notifications 206 is an icon on a display that when selected displays the notifications or may take the job seeker 502 to a GUI. In some embodiments, notifications 206 may evoke a sound or other indication on a device of the job seeker 502 to indicate a notification 206 is available.

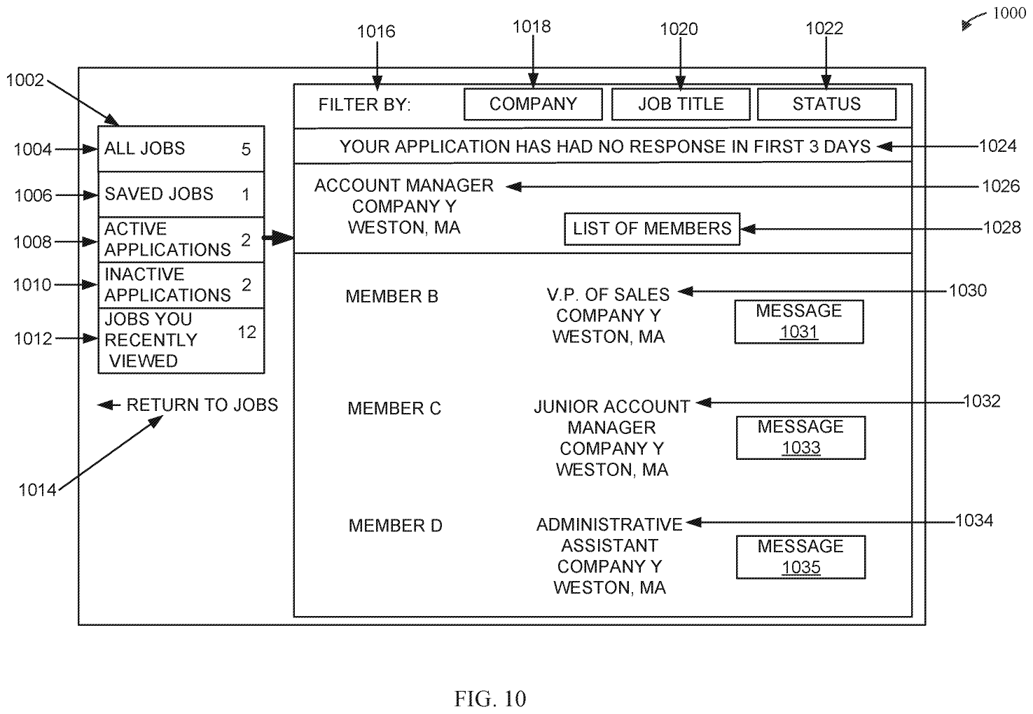

Email 208 may include information including notifications 206 and content items 204. Email 208 may indicate that new information is available on one of the GUIs (e.g., FIGS. 10-17). Email 208 may include information from one of the actions as described in conjunction with tables 1 and 2. Email 208 may be email that is sent by job seeker interactions 902 to the job seeker 502. The job seeker UI 210 may be GUIs that the job seeker 502 may use, e.g., FIGS. 10-17). Job seeker GUI 210 may be one or more GUIs that a job seeker 502 may use that is provided by the connection network system 100, e.g., GUIs as disclosed in conjunction with FIGS. 10-17.

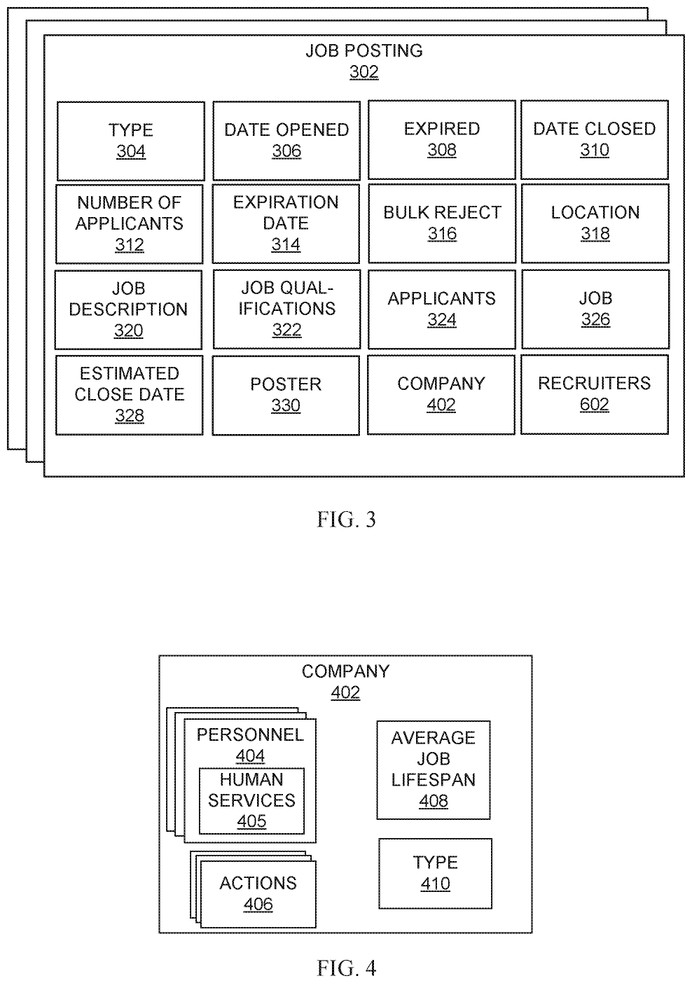

FIG. 3 illustrates a data structure of a job posting 302, in accordance with some embodiments. A job posting 302 may include one or more of the following: type 304, date opened 306, expired 308, date closed 310, number of applicants 312, expiration date 314, bulk rejection 316, location 318, job description 320, job qualifications 322, applicants 324, job 326, estimated close date 328, poster 330, company 402, and recruiters 602. The job 326 may include information about the job the job posting 302 is for. A type 304 may indicate a type of job, e.g., permanent, temporary, salaried, hourly, etc. The type 304 may indicate whether the job posting 302 is a paid advertisement, limited time posting, etc. The type 304 may indicate whether the job posting 302 was from the connection network system 100 or gathered from outside the connection network system 100, e.g., from information sources 122.

Date opened 306 may indicate when applications for the job 326 of the job posting 302 may be submitted. Expired 308 may indicate whether the job posting 302 has expired. Date closed 310 may indicate whether the job posting 302 is closed or not. Number of applicants 312 may indicate a number of applicants 312 that have applied for the job posting 302 and may indicate which job seekers 502 have applied. In some embodiments, the number of applicants 312 may include applicants that have applied through the connection network system 100. In some embodiments, the number of applicants 312 may include applicants that applied outside the connection network system 100.

Expiration date 314 may be a date when the job posting 302 expires. Bulk reject 316 may indicate whether a poster 330 that posted the job posting 302 has used an action 406 of bulk reject to reject applicants 324. The location 318 may indicate a location of the job 326. The job description 320 may be a description of a job 326 of the job posting 302, which may include a title and salary information as well as other information. The job qualifications 322 may be qualifications (e.g., years of experience, education, etc.) required or recommended for the job of the job posting 302. The applicants 324 may be job seekers 502 that have applied for the job 326 of the job posting 302. In some embodiments applicants 324 may indicate a number of applicants 324 that applied to the job 326 of the job posting 502 through a different means other than the connection network system 100. Company 402 may be the same or similar as company 402 as disclosed in conjunction with FIG. 4. The poster 330 may be the entity that posted the job posting 302, e.g., recruiter 602 or company 402 (e.g., human services 405). Recruiters 602 may be the same or similar as recruiters 602 as disclosed in conjunction with FIG. 6. The job 326 may have more than one job posting 302.

FIG. 4 illustrates a data structure of a company 402, in accordance with some embodiments. The company 402 may include personnel 404, actions 406, average job lifespan 408, and type 410. The company 402 may be a corporation, limited liability corporation, partnership, sole ownership, etc. The personnel 404 may be a data structure that indicates people that work for the company 402, e.g., managers, recruiters, human resources, etc. The personnel 404 may be members 802 of the connection network system 100. The personnel 404 may include a data structure of human services 405, that indicates personnel 404 that work for a human services portion of the company 402. People that work for human services 405 may be the people that are associated with or posted the job posting 302 (e.g., poster 330). The actions 406 may be a data structure that indicates actions 406 that the company 402 has taken or may take, e.g., posting the job posting 302, hiring a person for the job 326, bulk rejecting 316 applicants 324, an action from Table 1 or 2, viewing a member profile 804 of a job seeker 502, messaging a job seeker 502, etc. The actions 406 may be performed by personnel 404, e.g., human services 405. Average job lifespan 408 may indicate an average time between date opened 306 and date closed 310 for job postings 302 where the company 402 is the poster 330. The type 410 may indicate a type of the company 402, e.g., a corporation, limited liability corporation, partnership, sole ownership, etc.

FIG. 5 illustrates a data structure of a job seeker 502, in accordance with some embodiments. Job seeker 502 may include saved jobs 504, active jobs applied to 506, inactive jobs applied to 508, available jobs 510, characteristics 512, and resume 514. Job seeker 502 may be a member 802 as disclosed in conjunction with FIG. 8. Saved jobs 504 may be jobs 326 and/or job postings 302 that are saved by the job seeker 502. Active jobs applied to 506 may be jobs 326 and/or job postings 302 the job seeker 502 has applied to. Inactive jobs applied to 508 may be jobs 326 and/or job postings 302 the job seeker had applied to but have become inactive, e.g., expired 308 indicates the job posting 302 and/or job 326 are expired. Available jobs 510 may be jobs 326 and/or job postings 302 that may be available for the job seeker 502. For example, job seeker interactions 902 may determine available jobs 510 based on a member profile 804 of the job seeker 502, saved jobs 504, active jobs applied to 506, inactive jobs applied to 508, attributes of job posting 302, as well as comparing job seeker 502 to other job seekers 502 relative to which jobs 326 job seekers 502 have been successful with, e.g., received a message or view of a member profile 804 from a person associated with the job 326 or job posting 302. Resume 512 may be a resume of the job seeker 502. The resume 512 may be different than the member profile 804 of the job seeker 502. In some embodiments, the resume 512 is included in the member profile 804 and available on the connection network system 100.

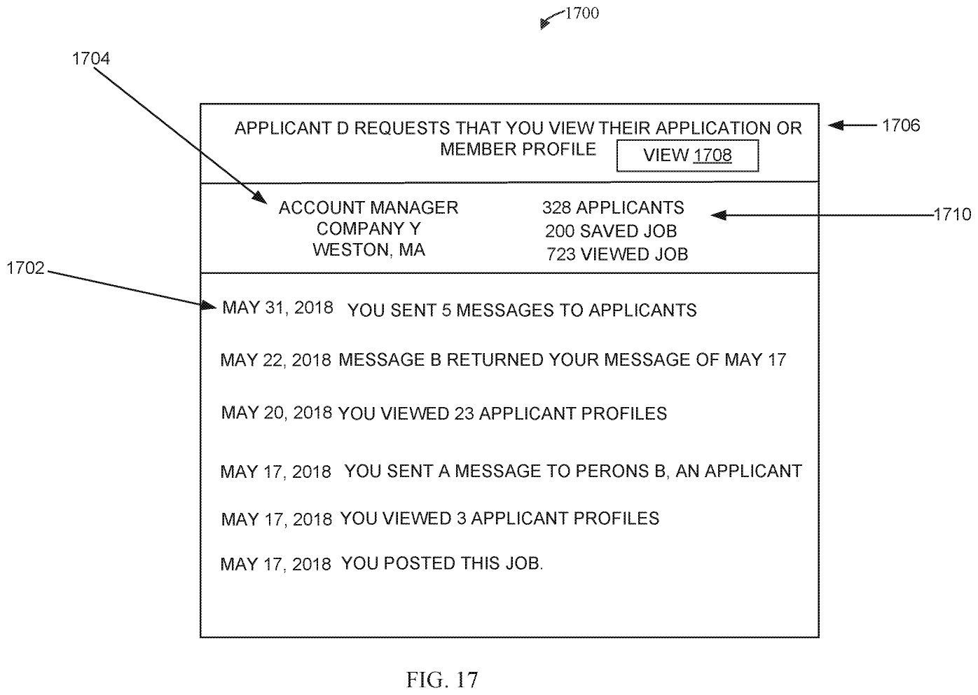

FIG. 6 illustrates a data structure of a recruiter 602, in accordance with some embodiments. Illustrated in FIG. 6 is recruiter 602, which may include actions 604, recruiter GUI 606, and average job lifespan 608. The recruiter 602 may be a member 802. A recruiter 602 may have a financial interest in filling the job 326 or may be the poster 330. The actions 604 may be actions the recruiter 602 has taken or may take, e.g., posted the job posting 302, viewed a member profile 804 of a job seeker 502, messaged a job seeker 502, bulk rejected 316 applicants 324, and as described in conjunction with Tables 1 and 2. Recruiter GUI 606 may be a GUI that the recruiter 602 may use to take actions 604, e.g., send messages or receive messages. FIG. 17 illustrates an embodiment of a recruiter GUI 606. Average job lifespan 608 may indicate an average time between date opened 306 and date closed 310 for job postings 302 where the company 402 is the poster 330.

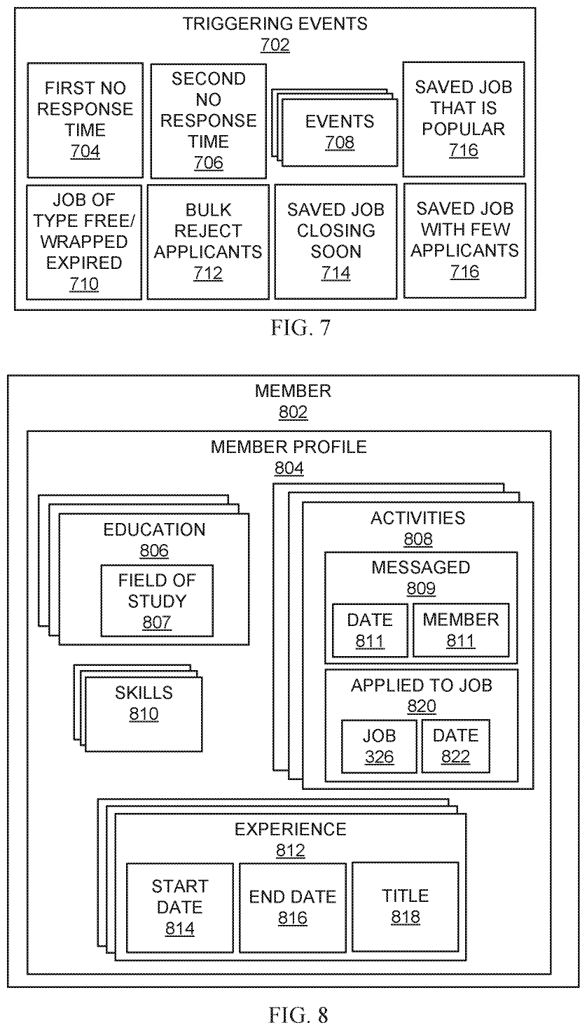

FIG. 7 illustrates a data structure of triggering events 702, in accordance with some embodiments. Illustrated in FIG. 7 is trigger events 702, which may include data structures for first no response time 704, second no response time 706, events 708, saved job that is popular 716, job of type free/wrapped expired 710, bulk reject applicants 712, saved job closing soon 714, and saved job with few applicants 716. Job seeker interactions 902 may be triggered if an event in triggering events 702 is true. The events in triggering events 702 may be as disclosed herein, e.g., in conjunction with Tables 1 and 2. Events 708 may be a data structure that indicates events that trigger job seeker interactions 902 to perform an action, in accordance with some embodiments. The connection network system 100 may monitor the events indicated by triggering events 702 and invoke job seeker interactions 902 when one of the triggering events 702 occurs.

FIG. 8 illustrates a data structure of a member 802, in accordance with some embodiments. Illustrated in FIG. 8 is member 802, which may include member profile 804. Member 802 may be a member 802 of the connection network system 100. Member profile 804 may include information regarding the member 802. Member profile 804 may include education 806, activities 808, skills 810, and experience 812. Member profile 804 may include one or more additional fields. Education 806 may indicate educational degrees (e.g., high school degree, bachelor, law degree, etc.) that the member 802 has received and may include field of study 807, e.g., biology, business, computer science, etc. Skills 810 may include skills such as computer languages, certificates, etc. Activities 808 may include messaged 809 and applied to job 820. Activities 808 may include one or more additional activities. Activities 808 may be stored in member activity and behaviour data 120.

Messaged 809 may indicate a date 811 and member 811 that the member 802 messaged. Applied to job 820 may include a job 326 and date 822 that the member 502 applied to a job 326. The job 326 may include an indication of a job posting 302 for the job 326. Experience 812 may include start date 814, end date 816, and title 818 of one or more jobs the member 502 has held. The member profile 804 may be stored in the profile data 116.

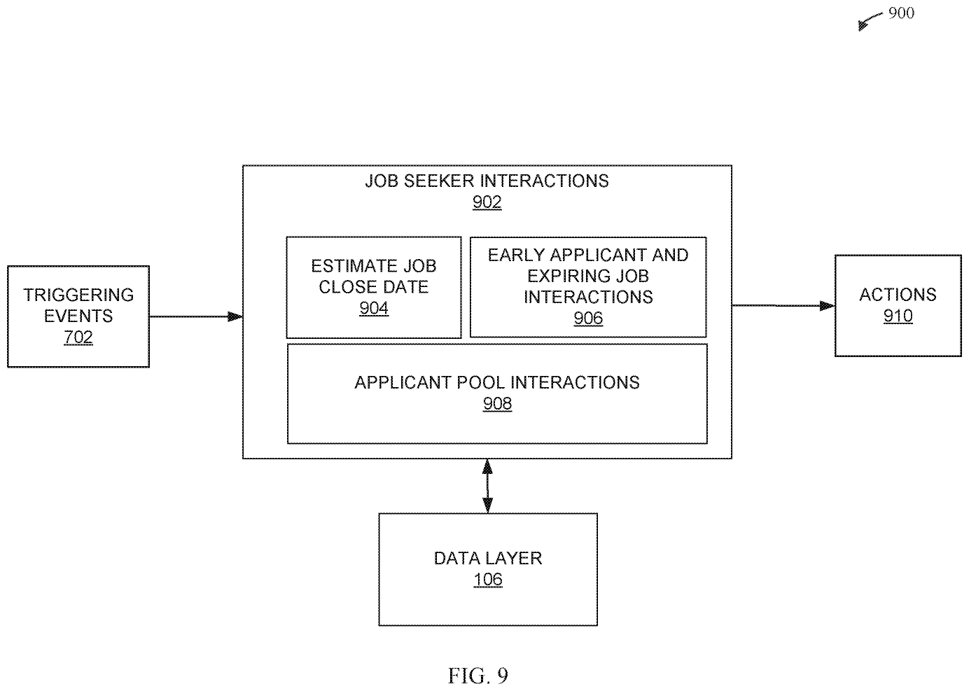

FIG. 9 illustrates a system 900 for job seeker interactions, in accordance with some embodiments. Illustrated in FIG. 9 is job seeker interactions 902, triggering events 702, actions 910, and data layer 106. Triggering events 702 may be the same or similar as trigger events 702 as disclosed in conjunction with FIG. 7. Data layer 106 may be the same or similar as data layer 106 as disclosed in conjunction with FIG. 1. Job seeker interactions 902 may include estimate job close date 904, early applicant and expiring job interactions 906, and applicant pool interactions 908. Job seeker interactions 902 may be an application server module 110 as disclosed in conjunction with FIG. 1. Job seeker interactions 902 may be triggered by an event of triggering events 702 and perform an action 910 based on the event and the data layer 106.

Estimate job close date 904 may estimate when a job 326 of a job posting 302 will close, e.g., estimated close date 328. Estimating the estimated close date 328 may enable job seeker interactions 902 to notify the job seeker 502 prior to the job 326 closing when an expiration date 314 is not known. In some embodiments, estimate job close date 904 will determine estimated close date 328 based on historical data of jobs 326 of job postings 302 by the same company 402. In some embodiments, estimate job close date 904 may predict the estimated close date 328 for paid jobs, e.g., jobs for which the poster 330 of the job 326 is known. In some embodiments, 75% of jobs 326 are paid jobs. In some embodiments estimate job close date 904 determines estimated close date 328 based on historical data from jobs 326 posted during a time period, e.g., a month such as April 2018 or a year such as 2018. In some embodiments, based on historical data from February 2018 through July 2018, estimate job close date 904 determined that 64% of paid jobs have a close date 904 within seven (7) days of the average lifespan of jobs 326 posted by the same company 402. In some embodiments, 90% of paid jobs are posted by repeat posters 330, so historical data for a job posting 302 is often available. In some embodiments, there is a high variance of job lifespans (e.g., date opened 306 through date closed 310). In some embodiments, an average job lifespan (e.g., average job lifespan 408) for a job poster 330 (e.g., company 403 or recruiters 602) is used to predict the job lifespan. The close date may be estimated as the date opened 306 plus the average job lifespan 408, 608, in accordance with some embodiments. For example, jobs 326 posted (poster 330) by Tom (a recruiter 602 for company X in human services 405, e.g., company 403) close on average after 30 days, e.g., average job lifespan 408 equal to 30 days. Continuing the example, eight (8) days ago, Tom posted a job posting 302 for a job 326 for a software engineer at company X. The formula to determine the estimated days to job closing (e.g., date closed 310) is: Equation (1): estimated days to job closing=average job lifespan (e.g., 408, 608)—days already open. In the example above, 22=(30−8). In some embodiments, one may be subtracted or added to Equation (1). In some embodiments, the estimated days to job closing may trigger a triggering event 702 if the number of days is below a threshold value.

In some embodiments, estimate job close date 904 may use Equation (1) as a default when historical data is not available for the poster 330 of the job 326. In some embodiments, if Equation (1) indicates a close date less than a threshold number of days, e.g., 12 days, then job seeker interactions 902 may cause a decoration 1626 to be displayed with a job card 1600. The decoration 1626 may indicate that the job 326 is closing soon or in an estimated number of days. In some embodiments, estimate job close date 904 is configured to match jobs 326 with similar conditions as a job 326 (e.g., based on one or more of the attributes 304, 306, . . . , 330, 402, 602) and determine if the matched jobs 326 indicate that there is over a threshold percent chance the job 326 will close within five (5) days (or another number of days that may be chosen to raise the probability of the chance the job will close). If there is over a threshold percent chance the job 326 will close within the threshold number of days, then a decoration 1626 (e.g., “This job may stop accepting applications soon. Apply Now.”) may be displayed to the job seeker 502.

In some embodiments, other jobs 326 that have already closed are matched to the job 326. If 60% (or another percentage) of the jobs 326 matched to the job 326 closed within a threshold number of days (e.g., 5 days) after the current number of days the job 326 has been open, then a decoration 1626 is displayed. In some embodiments, there may be a false positive rate of (e.g., 40%,) which means that the decoration 1626 may be shown when the job 326 does not close within a second threshold number of days, e.g., 5 or 12 days. In some embodiments, there is a false negative rate (e.g., 13%), which means the decoration 1626 may not be shown when the job 326 does close within a second threshold number of days, e.g., 5 or 12 days. In some embodiments, there is a coverage percentage (e.g., 62%), which means the percentage of jobs 326 for which the decoration 1626 may be shown for jobs 326 that do not have an expiration date 314 for the job posting 302. Actions 910 may be actions as described herein, e.g., in Tables 1 and 2.

In some embodiments, early applicant and expiring job interactions 906 and/or applicant pool interactions 908 may be configured to refrain from displaying a message (e.g., list of member 1028, common traits of job seekers who heard back 1128, jobs where you are more likely to get noticed 1206, similar jobs 1212, message 1306, message 1406, message 1506, decoration 1626, and hover mouse message 1624) unless it has been a threshold number of days since the job seeker 502 applied to the job 326 and/or unless there is at least one insight or interaction that can be generated (e.g., Tables 1 and 2 and/or actions 910). In some embodiments, early applicant and expiring job interactions 906 and/or applicant pool interactions 908 may be configured to display one message (e.g., list of member 1028, common traits of job seekers who heard back 1128, jobs where you are more likely to get noticed 1206, similar jobs 1212, message 1306, message 1406, message 1506, decoration 1626, and hover mouse message 1624) if one message may be generated, two (2) messages if two messages are generated, and two messages (or another number higher than two (2)) if three or more messages are available, where the two message (or another number higher than two (2)) may be selected randomly from the three or more messages, in accordance with some embodiments.

In some embodiments, job seeker interactions 902 is configured to determine if there are actions 902 after a threshold number of days after the job seeker 502 applies to a job 326, after a second threshold number of days after the job seeker 502 saved a job 326 to saved jobs 504, and after a job 326 closes. In some embodiments, job seekers 502 save 4.3 million jobs to saved jobs 504 per week with 400K jobs 326 of the 4.3 million jobs 326 expected to expire within three (3) days of being saved.

Applicant pool interactions 908 and/or early applicant and expiring job interaction 906 may be configured as disclosed in conjunction with Tables 1 and 2, and FIGS. 10-20. Table 1 illustrates rows, trigger event, and actions. The row indicates which row of Table 1. The triggering event may be a triggering event 702 as disclosed in conjunction with FIG. 7. The action may be an action 910 that is taken, e.g., by expiring job interactions 906, in response to the triggering event 702.

TABLE 1

| Row | Triggering Event | Action |
|---|---|---|
| 1 | Job seeker 502 applied to job and | Suggest list of members 802 that |
| | received no response within 3 days. | work at company 402 of the job |
| | | 326 but that are not involved in |
| | | the hiring for the job 326. |
| 2 | Job seeker 502 applied to job and | Suggest Completing Member |
| | received no response within 3 days. | profile 804. |
| 3 | Job seeker 502 applied to job and | Display Common traits of |
| | received no response within 7 days. | successful Job Seekers 502. |
| 4 | Job seeker 502 has applied to a job which | |
| | has manually closed. | |
| 5 | Job seeker 502 has applied to a job of | |
| | type free/wrapped job which has expired. | |
| 6 | Job seeker 502 rejected from job by bulk | |
| | reject feature. | |
| 7 | Job seeker 502 rejected from | Display similar Jobs 326, which |
| | job by bulk reject feature. | may include a display of a map |
| | | to browse the jobs 326, where |
| | | the jobs 326 may be decorated |
| | | (e.g., 1626) or ranked by |
| | | number of applicants 324 (less |
| | | applicants a greater chance of |
| | | interaction). |
| 8 | Job seeker 502 saves job 326 within three | Prompt jobseeker that job 326 is |
| | (3) days of expiration date 314 of job | expiring soon and they should submit |
| | 120. | application as soon as possible. |
| 9 | Job Seeker 502 saves job 326 to saved | Prompt job seeker 502 that applying |
| | jobs 504 where the job posting 302 has | earlier significantly boosts chance |
| | been posted recently or has <30 applicants. | of hearing back. |
| 10 | Job Seeker 504 saves job 326 to saved | Display others are applying, |
| | jobs 504 where the job posting 302 has | apply soon, e.g., “This job is |
| | been posted recently or has <30 | popular. Has received 30 applies |
| | applicants. | in the last day. Apply soon!” |

Row 1 of Table 1 illustrates a triggering event 702 where a job seeker 502 applied to a job 326 and received no response within three (3) days (e.g., 1024). The action may be that expiring job interactions 906 may suggest a list of members 802 (e.g., 1030, 1032, 1034) that work at the company 402 (e.g., Company Y) of the job 326. The first no response time 704 may be a triggering event 702 (e.g., 1024) with the first no response time being three (3) days. FIG. 10 illustrates an example of row 1. In some embodiments, the action may be conveyed to the job seeker 502. In some embodiments, 98% of job seekers 502 receive no interaction from job poster 330 or recruiter 602 within three (3) days. Tables 1 and 2 and FIGS. 9-18 are disclosed in conjunction with one another.

FIG. 10 illustrates a Graphical User Interface (GUI) 1000 showing a triggering event where the first response time has elapsed, in accordance with some embodiments. Illustrated in FIG. 10 is a user interface 1000 for a job seeker 502. Along the left is a menu 1002 with options that include all jobs 1004, saved jobs 1006, active application 1008, inactive applications 1010, and jobs you recently viewed 1012. All jobs 1004 may include all the jobs 326 the job seeker 502 has saved (saved jobs 1006), applied to with an active application (active applications 1008), and applied to with an inactive application (inactive applications 1010). The saved jobs 1006 may be the same or similar as saved jobs 504. Active applications 1008 may be the same or similar as active jobs applied to 506. Inactive applications 1010 may be inactive jobs applied to 508. Jobs you recently viewed 1012 may be jobs 326 that the job seeker 502 has viewed recently, e.g., by using a GUI.

Return to jobs 1014 may be a button to return from GUI 1000 to another GUI for jobs 326, e.g., an GUI to search for jobs or a home page of the connection network system 100. Filter by 1016 enables the job seeker 502 to filter the jobs 1026 that are displayed, by company 1018, job title 1020, and status 1022. As illustrated only job 1026 is being displayed.

A triggering event may be displayed at 1024. In this case the job seeker 502 applied to job 1026 and has no response in the last three (3) days. List of members 1028 may be a button that enables the job seeker 502 to display the members 1030, 1032, and 1034, or not. The members 1030, 1032, and 1034 may be members that work at the same company as the job 102. Each member 1030, 1032, 1034 may include a message 1031, 1033, 1035 button that will message a corresponding member 1030, 1032, 1034, when selected. The members 1030, 1032, 1034, may be selected based on being connected to the job seeker 502 within the connection network system 100. The members 1030, 1032, 1034, may be selected based on titles of jobs 326 the members 1030, 1032, 1034, hold compared with a title of the job 1026.

Row 2 of Table 1 illustrates a triggering event 702 where a job seeker 502 may apply to a job 326 and receive no response within three (3) days (e.g., 1024). In this case, expiring job interactions 906 may suggest that the job seeker 502 complete a member profile 804. For example, the job seeker 502 may be a member 802 with a member profile 804. The early applicant and expiring job interactions 906 may examine the member profile 804 and determine that one or more attributes or fields are not completed that may help the job seeker 502 or that may have been completed by job seekers 502 that received actions 406, 604 (e.g., messages, profile views, or job offers). The first no response time 704 may be a triggering event 702 (e.g., 1024) with the first no response time being three (3) days. Early applicant and expiring job interactions 906 may interface with the job seeker 502 via the feed 202 (e.g., the list of members 1030, 1032, 1034 may be replaced by a notice to complete the profile 804 or a display of the profile 804 with portions highlighted that are recommended to be completed or edited), notifications 206 (e.g., a notification to click on it to complete a portion of the member profile 804), an email 208 that may include hot links, and/or a job seeker GUI 210. In some embodiments, 46% of job seekers 502 apply to jobs 326, which get one (1) interaction (i.e., message from job poster 330 or recruiter 602, or a member profile 804 view) within seven (7) days of applying to the job 326.

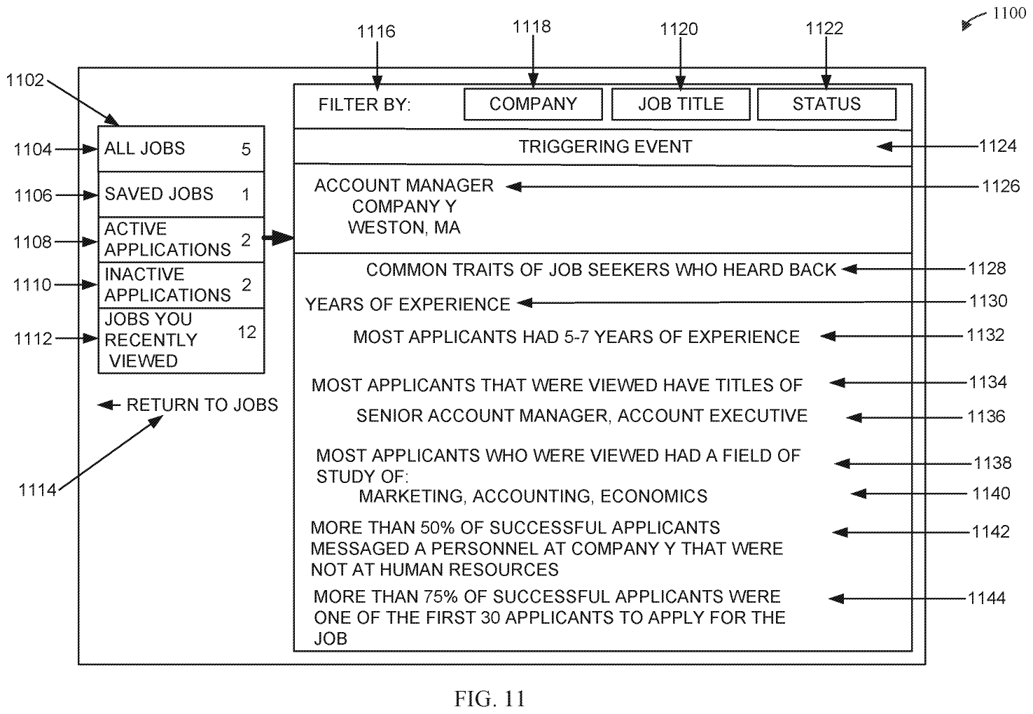

Rows 3-6 of Table 1 illustrates triggering events that all have a same or similar action of display common traits of successful job seekers 502. Successful job seekers 502 may be job seekers that have had their member profile viewed 804 or have been messaged by a member associated with the job 326 (e.g., poster 330 of job posting 302 of job 326), e.g., personnel 404 of company 402 (e.g., that are part of human services 405) and/or a recruiter 602. In some embodiments, a successful job seeker 502 may be determined based on another action 406, 604 of the company 402 and/or recruiter 602. Row 3 has the triggering event of job seeker 502 applied to job 326 and received no response within seven (7) days. The second no response 706 may be seven (7) days. Row 4 has the triggering event of job seeker 502 applied to job 326 and the job 326 has manually closed, e.g., date closed 310 is true with a date, and/or actions 406, 604, indicate a manual close to the job 326. Row 5 has the triggering event of job seeker 502 applied to job 326 and the job 326 has a type 304 of free/wrapped, which has expired (e.g., expired 308). Row 6 has the triggering event of job seeker 502 applied to job 326 and the job seeker 502 was rejected using bulk reject 316. The action for rows 3-6 is display common traits of job seekers 502 who have heard back, which is illustrated in FIG. 11. In some embodiments, job seekers 502 that apply to a job 326 early (e.g., first 30 applicants) have a three times more likely chance of getting an interaction than applicants who apply after the 199th applicant.

FIG. 11 illustrates an example GUI showing common traits of job seekers who heard back 1100, in accordance with some embodiments. FIG. 11 and Table 2 will be disclosed in conjunction with one another. Illustrated in FIG. 11 is a user interface 1100 for a job seeker 502. Along the left is a menu 1102 with options that include all jobs 1104, saved jobs 1106, active application 1108, inactive applications 1110, and jobs you recently viewed 1112. Menu 1102 and options may be the same or similar as menu 1002. Return to jobs 1114 may be the same or similar as return to jobs 1014.

The actions of rows 3-6 of Table 1 may be to display common traits of successful job seekers, in accordance with some embodiments. In some embodiments, the actions of row 3-6 may be presented to the job seeker 502 using feed 202, notifications 206, email 208, and/or job seeker UI 210. Applicant pool interactions 908 may be configured to determine common traits of successful job seekers 502. Table 2 illustrates an embodiment of common traits of successful job seekers.

Rows of Table 2 include category, insight, minimum samples, determination, and example display of determination. Row 1 indicates that the category is background (e.g., experience 812 may be part of a background of a member profile 804). Row 1 indicates the insight is years of experience, e.g., 1130. Row 1 indicates the determination is determine total years of experience of successful job seekers 502. In some embodiments, the total years of experience is determined by applicant pool interactions 908 determining total years of experience (e.g., using start date 814, end date 816, and a current date where the title 818 may be used to only include non-intern positions or to only include paid positions) for each successful job seeker 502. The applicant pool interactions 908 may bucket each successful job seeker 502 into one (1) of seven (7) buckets for total years of experience: 0-1.99, 2-3.99, 4-5.99, 6-9.99, 10-13.99, 14-19.99, and 20+, in accordance with some embodiments.

Applicant pool interactions 908 may determine if any one bucket has greater than 50°/a of the applicants. Applicant pool interactions 908 may display the results, e.g., at 1132, applicant pool interactions 908 displays that “most applicants had 5-7 years of experience.” If no bucket had greater than 50%, then applicant pool interactions 908 would display “applicants who were viewed had a wide variety of years of experience”, in accordance with some embodiments. The language of displays may be different. In some embodiments, applicant pool interactions 908 may display the actual number of successful job seekers 502 per bucket (and the buckets may be different ranges of experience).

TABLE 2
Common Traits of Successful Job Seekers

| | | | Minimum | | Example Display of |
|---|---|---|---|---|---|
| Row | Category | Insight | Samples | Determination | Determination |
| 1 | Background | Years of | 3 | Determine total | Display |
| | | Experience | | years of experience | If a bucket has >50% of |
| | | | | for each successful | successful applicants in it, |
| | | | | job seeker 502. For | then display |
| | | | | example, determine | Most applicants who were |
| | | | | number of years of | viewed have X-Y years of |
| | | | | experience for each | experience. |
| | | | | experience 812 | Otherwise display a message, |
| | | | | based on start date | e.g., Applicants who were |
| | | | | 814, end date 816 | viewed had a wide variety of |
| | | | | and current date. In | years of experience |
| | | | | some embodiments, | |
| | | | | experiences 812 | |
| | | | | that are volunteer | |
| | | | | positions or intern | |
| | | | | positions are not | |
| | | | | included. | |
| | | | | Bucket successful | |
| | | | | applicant into 1 of 7 | |
| | | | | buckets (total years | |
| | | | | of experience): 0- | |
| | | | | 1.99, 2-3.99, 4-5.99, | |
| | | | | 6-9.99, 10-13.99, | |
| | | | | 14-19.99, 20+ | |
| 2 | Background | Primary | 3 | Determine | Display all single primary |
| | | Title | | standardized | titles that have 3+ |
| | | | | primary title for | successful job seekers 502. |
| | | | | each successful job | If multiple primary titles |
| | | | | seeker 502. | have 3+ successful job |
| | | | | | seekers 502, display a |
| | | | | | maximum number (e.g., 3) of |
| | | | | | titles in descending order of |
| | | | | | most successful job seekers |
| | | | | | 502. |
| 3 | Background | Field of | 3 | Determine | Display any single field of |
| | | Study | | standardized field of | study 807 that has three (or |
| | | | | study for each | another number) or more |
| | | | | successful job | successful j ob seekers 502. |
| | | | | seeker 502 (some | If multiple fields of study |
| | | | | may have multiple). | 807 have three (3) or more |
| | | | | If a job seeker 502 | successful job seekers 502, |
| | | | | has multiple fields | show only a number (e.g., 3) |
| | | | | of study, count all | of fields in descending order |
| | | | | fields of study 807 | of most successful job |
| | | | | as one (1) when | seekers 502. |
| | | | | determining how | A message may be displayed |
| | | | | many job seekers | such as most job seekers who |
| | | | | are in each field of | were viewed studied |
| | | | | study 807, in | Field of Study 1, |
| | | | | accordance with | Field of Study 2, |
| | | | | some embodiments. | Field of Study 3. |
| | | | | | If no single field of study 807 |
| | | | | | has three (or another number) |
| | | | | | or more successful job |
| | | | | | seekers display that no |
| | | | | | field of study was popular for |
| | | | | | successful job seekers 502. |
| 4 | Activity | Network | 1 | Determine if any | Display an indication of a |
| | | | | successful job | percentage of the successful |
| | | | | seekers 502 had | job seekers 502 that did message |
| | | | | messaged personnel | personnel 404 at the company |
| | | | | 404 at the company | 402. The percentage may be |
| | | | | 402 of the job 326 | estimated, e.g., If 50-74.99 |
| | | | | between 2 weeks | show 50%, If 75-89.99, show |
| | | | | before and 2 weeks | 75%, and If 90+, show 90%. |
| | | | | after the time they | An example message may |
| | | | | applied to the job | be: more than [50, 75, 90]% |
| | | | | 326. In some | of job seekers whose member |
| | | | | embodiments, the | profile was viewed reached |
| | | | | personnel 404 is not | out to someone at the |
| | | | | associated with | company. |
| | | | | hiring for the job | If a threshold percentage of |
| | | | | 326, e.g., the | successful job seekers that |
| | | | | personnel 404 is not | reached out is not reached, an |
| | | | | part of human | example message may be: |
| | | | | services 405. | both job seekers who did and |
| | | | | | did not reach out to someone |
| | | | | | at the company were viewed. |
| 5 | Activity | Early | 1 | Determine if any | Display more than a percent |
| | | Applicant | | successful job | (e.g., 50%) of successful job |
| | | | | seekers were the | seekers were the 30^{th} |
| | | | | 30^{th} or | (or another number) or lower |
| | | | | lower applicant to the | applicant to the job: |
| | | | | job 326 | If 50-74.99, show 50% |
| | | | | | If 75-89.99, show 75% |
| | | | | | If 90+, show 90%, in |
| | | | | | accordance with some |
| | | | | | embodiments. |
| | | | | | Display may be: more than |
| | | | | | [50, 75, 90]% of job seekers |
| | | | | | who were viewed were one |
| | | | | | of the first 30 to apply to the |
| | | | | | job. |
| | | | | | If the percentage is of |
| | | | | | successful job seeker that are |
| | | | | | one of the first 30 (or another |
| | | | | | number) applicants is low, |
| | | | | | then the following may be |
| | | | | | displayed. Both early and |
| | | | | | late applicants were |
| | | | | | successful job seekers. |

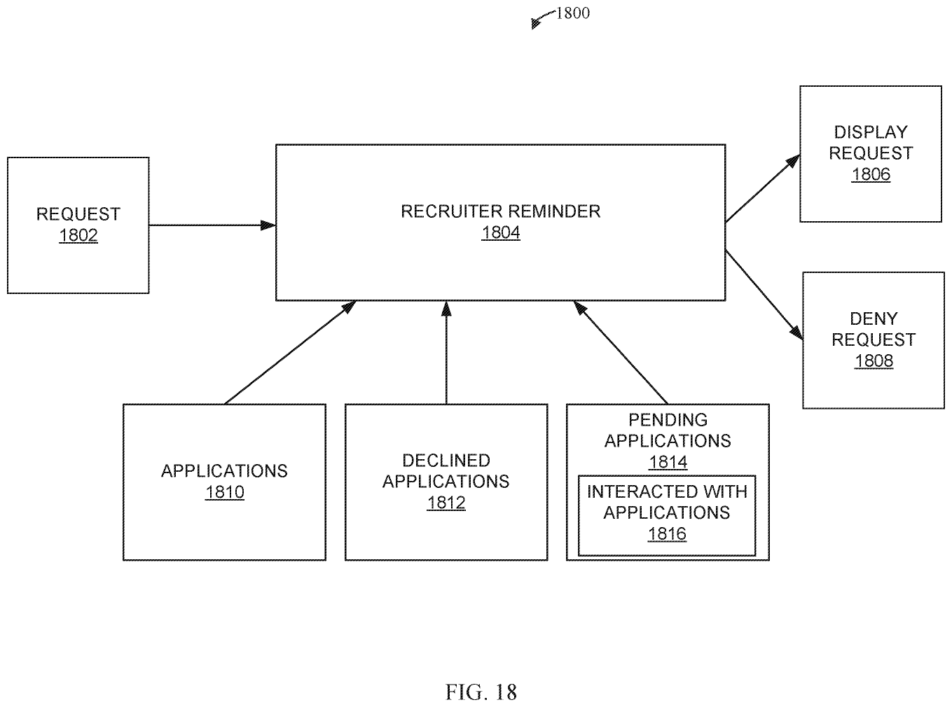

Row 2 of Table 2 indicates that the category is background (e.g., title 818 may be part of a background of a member profile 804). Row 2 indicates the insight is primary title, e.g., 1134. Row 2 indicates the action is determine standardized primary title for each successful job seeker 502. In some embodiments, the applicant pool interactions 908 will examine the member profiles 804 of successful job seekers 502 for the job 1126 to determine a primary title, e.g., applicant pool interactions 908 may determine a current job and the title 818 of the current job, and standardize the title 818. In some embodiments, applicant pool interactions 908 may standardize the title 818 by matching the title 818 to a database of job titles (e.g., part of information sources 112). Row 2 indicates that the following may be displayed (e.g., by applicant pool interactions 908). Primary titles that have three (3) (or a different number) or more successful job seekers 502 may be displayed. In some embodiments, only a threshold number of primary titles will be displayed. The primary title may be displayed in descending order of those that have the most successful job seekers 502. For example, applicant pool interactions 908 may display “most applicants that were successful have titles of:” 1134 and “senior account manager and account executive” 1136. A viewed application may be an interacted with application 1816 as disclosed in conjunction with FIG. 18. If no single primary title had three (3) (or another threshold) or more successful job seekers 502, then applicant pool interactions 908 may display an indication of this, in accordance with some embodiments.

Row 3 of Table 2 indicates that the category is background (e.g., field of study 807 may be part of a background of a member profile 804). Row 3 indicates the insight is field of study, e.g., 1138. Row 3 indicates the determination is to determine a standardized field of study for each successful job seeker 502 (some may have multiple) and if a successful job seeker 502 has multiple fields of study, count all fields of study, in accordance with some embodiments. For example, applicant pool interactions 908 may determine a standardized field of study (e.g., 1138) from field of study 807 of job seekers 502 that were successful for job 1126. Row 3 indicates that any single field of study that has three (3) (or another threshold) or more successful job seekers 502 may be displayed. The number of fields of study may be limited to three (3) (or another threshold). The fields of study may be display in descending order of most successful job applicants 502. In some embodiments, a maximum of three fields of study are displayed. For example, applicant pool interactions 908 may deter mine that marketing, accounting, and economics 1140 all had three (3) or more successful job seekers 502. One or more additional fields of study 1138 may have been determined to have three (3) or more successful job seekers 502, but were not displayed to provide a more concise interface of information for the job seeker 502. For example, applicant pool interactions 908 may display “Most applicants who were viewed had a field of study of:” 1138, and the fields of study 1140, “marketing, accounting, economics.”

Row 4 of Table 2 indicates that the category of network may be activity. For example, activities 808 of member profile 804. Row 4 indicates that the insight is network. Row 4 indicates that a minimum sample may be one (1). Row 4 indicates that action may be determine if any successful job seekers 502 had messaged a member at the company 402 of the job 326 (e.g., a member 802 who is not a recruiter 602 or a human services 405 personnel 404 at the company 402 of the job) between two (2) (or another threshold) weeks before and two (2) (or another threshold) weeks after the time the successful job seeker 502 applied to the job 326. For example, applicant pool interactions 908 may look at the messaged 809 of successful job seekers 502 and determine if date 811 was within two (2) (or another threshold) weeks before the time the job seeker 502 was successful, e.g., actions 604, 406 of recruiter 602 or personnel 404, respectively, indicates a view of member profile 804 of job seeker 502 or that the recruiter 602 messaged the job seeker 502.

Row 4 indicates an example display of determination as an indication of a percentage of successful applicants that messaged the personnel 404 that were not human services 405 in a given time frame, e.g., if 50-74.99 show 50%, if 75-89.99, show 75%, and if greater than 90, show 90%. Row 4 indicates that, in some embodiments, the display may be to display an indication of a percentage (e.g., 50, 75, 90%) of successful job seekers 502. If a threshold percentage of successful job seekers 502 is no reached, then the display may be to display that both job seekers 502 who did and did not reach out to someone at the company were viewed. For example, applicant pool interactions 908 may deter mine that 50% of successful applicants (e.g., job seekers 502) reached out to someone at the company 402 of the job 1126 that was not a human services 405 personnel 404 at the company 402. Applicant pool interactions 908, in accordance with some embodiments, may display an indication that more than 50% of successful applicants messaged as indicated at 1142. In some embodiments, different messages may be displayed.

Row 5 of Table 2 indicates that the category is activity, e.g., a position of when a successful job seeker 502 applied to the job 326 may be in an activities 808 portion of a member profile 804 of a successful job seeker 502. Row 5 indicates that the insight is early application, e.g., indicating to job seekers 502 whether being an early applicant to a job 326 may be an important factor in determining the successful job seekers 502. Row 5 indicates that a minimum sample may be one (1). Row 5 indicates that a determination may be to determine if any successful job seekers 502 were the 30th (or another threshold) or lower applicant to the job 326. For example, applicant pool interactions 908 may determine whether any successful seekers 502 to the job 326 applied early or were part of the first 30 (or another threshold) job seekers 502 that applied. Row 5 indicates example display of determination may be percentage categories to indicate percentages of the success job seekers 502 that were early applicants. An example display may be to indicate that both early and late applicants were successful if a threshold percentage is not reached.

For example, applicant pool interactions 908 may determine a percentage of successful job seekers 502 that were the first 30 (or another threshold) applicants to apply. Applicant pool interactions 908 may then display a percentage if the percentage is above a threshold or display that both applicants that applied early and applicants that did not apply early were successful candidates. In FIG. 11, applicant pool interactions 908 at 1144 may display that 75% of success applicants were one of the first 30 applicants to apply to job 1126.

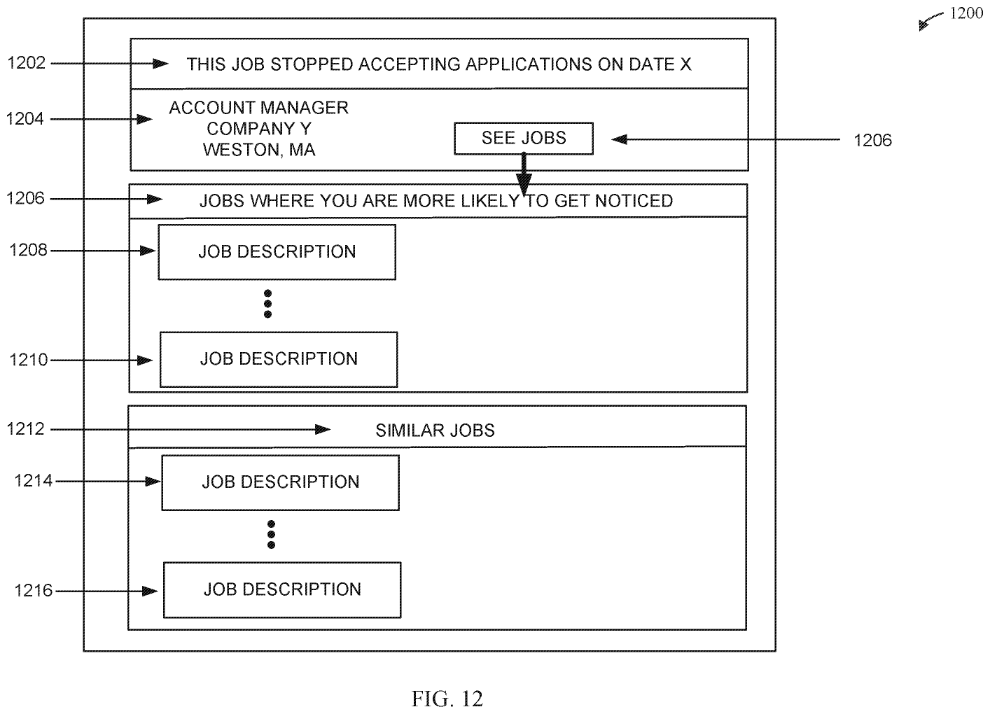

Returning to Table 1, row 7 indicates a trigger event of job seeker 502 rejected from job by bulk reject feature, e.g., bulk reject applicants 712. For example, a triggering event 702 may be bulk reject applicants 712. As an example, human services 405 or recruiter 602 may use a bulk reject action 406, 604. Row 7 indicates the action may be to display similar jobs to the job seeker 502 where the job seeker 502 may have a greater chance of interaction. FIG. 12 will be disclosed in conjunction with row 7. FIG. 12 illustrates an example GUI displaying suggested jobs 1200, in accordance with some embodiments. Illustrated in FIG. 12 is an indication of the job status 1202, i.e., that it is no longer accepting applications. A job description 1204 of the job that is no longer open. A button labelled “see jobs” 1206, which may produce the job descriptions 1208 through 1210 and 1214 through 1216, in accordance with some embodiments. A title 1206 for jobs descriptions 1208 through 1210 where a job seeker 502 may be more likely to get a response from. A title 1212 for job descriptions 1214 through 1216 that indicates the jobs 326 of job descriptions 1214 through 1216 may be similar to the job 326 of the job description 1204. Returning to row 7 of Table 1, for example, early applicant and expiring job interactions 906 may determine job posting 302 where job seekers 502 with similar member profiles 804 as the job seeker 502 have had success. For example, job descriptions 1208 through 1210.

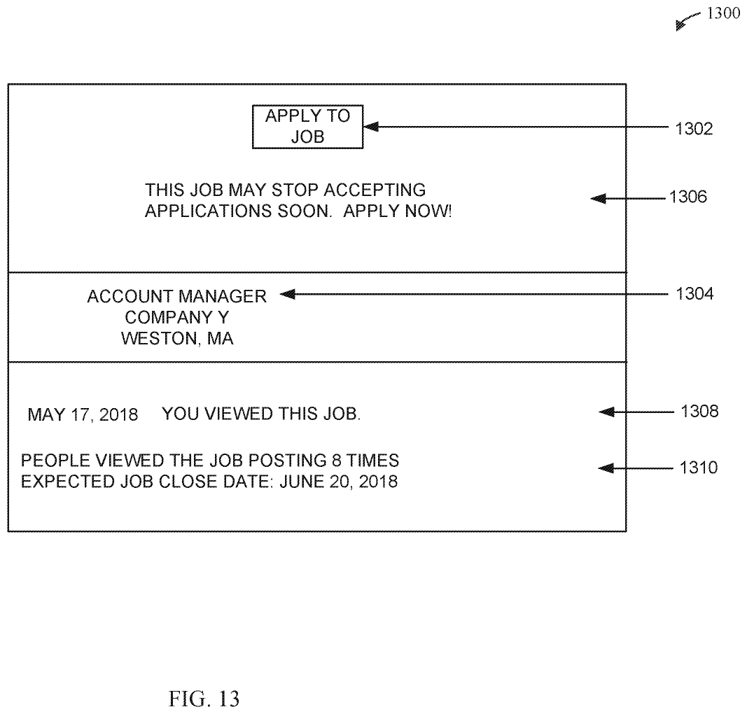

Row 8 indicates a trigger event of job seeker 502 saves a job within three (3) (or another threshold) days of an expiration date of job. Row 8 indicates an action of apply reminder, e.g., prompt job seeker to complete the application as the job is closing. For example, a triggering event 702 may be saved job closing soon 714. FIG. 13 will be discussed in conjunction with row 8. FIG. 13 illustrates an example of a GUI 1300 displaying an application reminder, in accordance with some embodiments. Illustrated in FIG. 13 is a button to apply to job 1302, message 1306, job description 1304, message 1308, and application information 1310. The button to apply to job 1302 may take the job seeker 502 to another interface to complete a job application for the job of job description 1304. The job description 1304 may be a description of the job the job seeker 502 viewed. Message 1306 may indicate to the job seeker 502 that the job of job description 1304 may close soon. Message 1308 may be a message of when the job seeker 502 viewed the job. Application information 1310 may provide information regarding other job seekers 502 who viewed the job and when the job may be closing. Returning to row 8, an example is that early applicant and expiring job interactions 906 may generate the information displayed in conjunction with FIG. 13.

Applicant and expiring job interactions 906 may use information associated with the member profile 804 and job seeker 502 to determine that a job 326 that the job seeker 502 saved may close within a threshold number of days, e.g., three (3) days. Some or all of the information presented in FIG. 13 may be presented to the job seeker 502 using the feed 202, notifications 206, email 208, and/or job seeker UI 210.

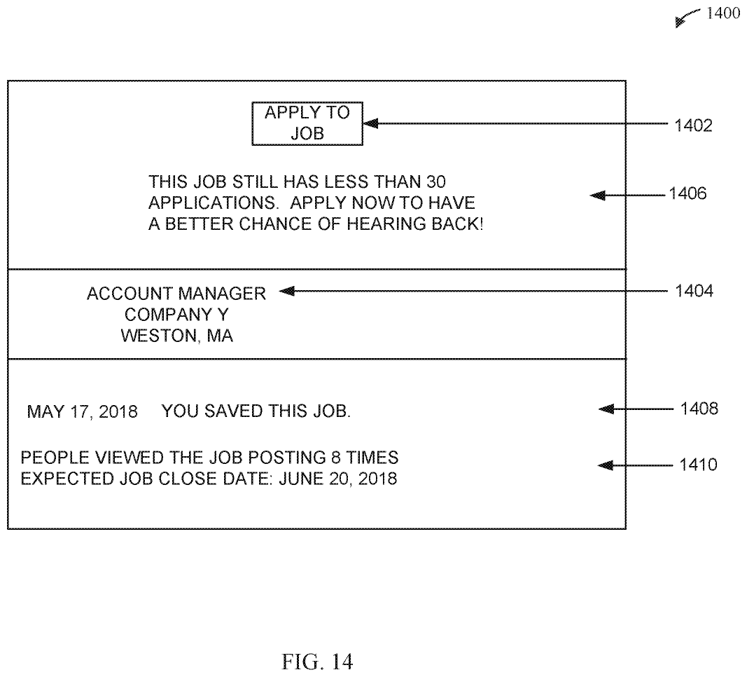

Row 9 of Table 1 indicates the triggering event is job seeker 502 saves a job 326 to saved jobs 504 where the job posting 302 has been posted recently or has less than 30 applications. For example, the triggering event 702 may be saved job with few applicants 716. Row 9 indicates the action is to prompt job seeker to apply to be an early applicant. FIG. 14 illustrates a GUI 1400 showing application suggestions, in accordance with some embodiments. FIG. 14 will be disclosed in conjunction with row 9. Illustrated in FIG. 14 is a button to apply to job 1402, message 1406, job description 1404, message 1408, and application information 1410. The button to apply to job 1402 may take the job seeker 502 to another interface to complete a job application for the job of job description 1404. The job description 1404 may be a description of the job the job seeker 402 applied to. The message 1406 may indicate to the job seeker 502 that it may be advantageous to be one of the first applicants, e.g., to apply below a threshold of applicants. Message 1408 may be a message of when the job seeker 502 saved the job, e.g., to saved jobs 504. Application information 1410 may provide information regarding applicants to the job and when the job may be closing. Some or all of the information presented in FIG. 14 may be presented to the job seeker 502 using the feed 202, notifications 206, email 208, and/or job seeker UI 210. Applicant and expiring job interactions 906 may use information associated with the member profile 804 and job seeker 502 to determine that a job 326 that the job seeker 502 saved has fewer than a threshold (e.g., 30) of job applicants.

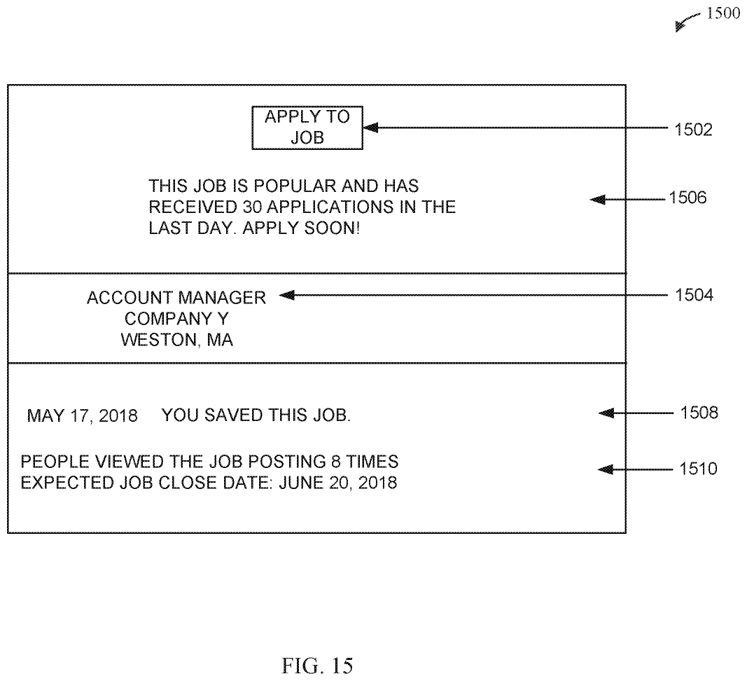

Row 10 of Table 1 indicates the triggering event is a job seeker 502 saves a job 326 to saved jobs 504 which is a popular job 326 with other job seekers 502. For example, triggering events 702 may be that a saved job that is popular 716. Row 10 indicates the action may be to provide a message to the job seeker that the job is popular. FIG. 15 will be discussed in conjunction with row 10. FIG. 15 illustrates a GUI 1500 showing application suggestions, in accordance with some embodiments. Illustrated in FIG. 15 is a button to apply to job 1502, message 1506, job description 1504, message 1508, and application information 1510. The button to apply to job 1502 may take the job seeker 502 to another interface to complete a job application for the job of job description 1504. The job description 1504 may be a description of the job the job seeker 502 applied to. The message 1506 may indicate to the job seeker 502 that the job is popular and indicate an approximate number of applicants to the job during a time period. Message 1508 may be a message of when the job seeker 502 saved the job, e.g., to saved jobs 504.

In some embodiments, the message 1506 may be a different message, e.g., “this job is a hot job. It has been viewed over 1000 times in the past week.” There may be multiple conditions to determine whether to display a message 1506. For example, the message 1506 may indicate that the job has been viewed 1000 times if the job 326 of the job description 1504 has received 1000 job views in the last seven (7) days and the job is the most viewed job 326 of all the saved jobs 504 of the job seeker 502. The message 1506 may be a decoration 1626 or hover mouse message 1624. Application information 1510 may provide information regarding applicants to the job and when the job may be closing. Some or all of the information presented in FIG. 15 may be presented to the job seeker 502 using the feed 202, notifications 206, email 208, and/or job seeker UI 210.

Applicant and expiring job interactions 906 may use information associated with the member profile 804, the job posting 302, and job seeker 502 to determine that a job 326 that the job seeker 502 saved has become popular. In some embodiments, job seekers 502 save jobs (e.g., to saved jobs 504) where a number of applicants 312 is below 30. Message 1506 may indicate that job seekers 502 are more than three times as likely to have an interaction for jobs 326 if they are one of the first 30 job applicants 312.

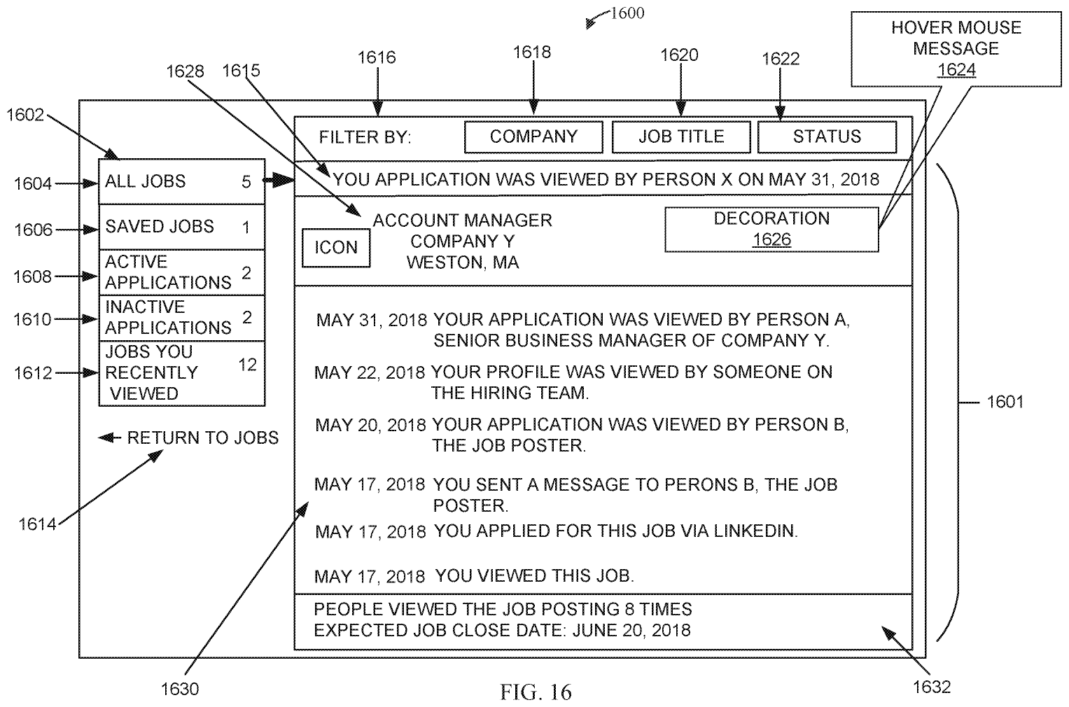

FIG. 16 illustrates a GUI 1600 for a job seeker, in accordance with some embodiments. The fields 1615, 1628, 1630, and 1632 may be a job card 1601. Along the left is a menu 1602 with options that include all jobs 1604, saved jobs 1606, active application 1608, inactive applications 1610, and jobs you recently viewed 1612. All jobs 1604 may include all the jobs 326 the job seeker 502 has saved (saved jobs 1606), applied to with an active application (active applications 1608), and applied to with an inactive application (inactive applications 1610). The saved jobs 1606 may be the same or similar as saved jobs 504. Active applications 1608 may be the same or similar as active jobs applied to 506. Inactive applications 1610 may be inactive jobs applied to 508. Jobs you recently viewed 1612 may be jobs (e.g., 326) that the job seeker 502 has viewed recently, e.g., by using a user interface. Return to jobs 1614 may be a button to return from user interface 1600 to another user interface, e.g., an interface to search for jobs. Filter by 1616 enables the job seeker 502 to filter the jobs 1626 that are displayed, by company 1618, job title 1620, and status 1622. As illustrated only job of job description 1628 is being displayed. Job description 1628 may illustrate information about the job 326, e.g., information included in the job posting 302. Message 1615 may be a message regarding activity related to job description 1628.

Icon (unnumbered) may be an icon associated with the company 402 (or recruiter 602) of the job of the job description 1628. Messages 1630 may be events regarding the job description 1628. Message 1632 may be messages related to other job seekers 502 who may be interested in the job of the job description 1628. The decoration 1626 may indicate a message to the job seeker 502 regarding the job of the job description 1628. For example, decoration 1626 may indicate that the job is closing soon or that there are still only a few applicants to the job. Hover mouse message 1624 may provide additional information regarding the job of the job description 1628. For example, the hover mouse message 1624 may indicate the job may close today. Additionally, both decoration 1626 and hover mouse message 1624 may include a link, e.g., to an interface to complete an application to the job of job description 1628.

In some embodiments, early applicant and expiring job interactions 906, estimate job close date 904, and/or applicant pool interactions 908 are configured to display decorations 1626 and/or hover mouse message 1624.

FIG. 17 illustrates a GUI 1700 for a job poster, in accordance with some embodiments. The user interface 1700 may be termed a job card. The user interface 1700 may include messages 1702, job description 1704, requests 1706, button 1708, and job posting statistics 1710. The messages 1702 may include actions taken by the poster 330 and actions taken by job applicants. The job description 1704 may be a description of job 326, e.g., from job posting 302. The request 1706 may be requests from job applicants 324. The requests may include a request that the job poster 330 (company 402 or recruiter 602) view an application or member profile 804 of an applicant 324. View 1708 may be a link to view the application or member profile 804 of an applicant 324. In some embodiments, an interface is presented that enables the job poster 330 to filter candidates, e.g., remove candidates from consideration based on certain criteria and/or based on selectively removing the candidate.

FIG. 18 illustrates a system to determine whether to display a request, in accordance with some embodiments. Illustrated in FIG. 18 is request 1802, recruiter reminder 1804, display request 1806, deny request 1808, applications 1810, declined application 1812, and pending applications 1814. Request 1802 may be a request to display a request to a job poster 330, e.g., request 1706. Display request 1806 may indicate the request 1802 has been granted to display a request and/or cause the request, e.g., 1706, to be displayed to a job poster 330. Deny request 1808 may indicate that a request 1802 is not granted. A message may be displayed on a job seeker 502 user interface that the request 1802 (e.g., to display request 1706) is denied. Applications 1810 may be applications 324 to a job 326. Declined applications 1812 may be applications 324 of the applications 1810 that have been declined. Pending application 1814 may include interacted with applications 1816. Pending applications 1814 may be applications that are still pending from the applications 1810. Interacted with applications 1816 may be pending applications 1814 that the job poster 330 interacted with (e.g., messaged or viewed the member profile 804). Recruiter reminder 1804 may be configured to take a request 1802 and determine whether to display request 1806 or deny request 1808. Recruiter reminder 1804 may be configured to compare an application of an applicate 324 and/or member profile 804 of a job seeker 502 that made the request 1802 with declined applications 1812 and pending applications 1814. Recruiter reminder 1804 may determine whether the job seeker 502 more closely matches declined applications 1812 or pending applications 1814. Recruiter reminder 1804 may deny request 1808 if the job seeker 502 that made the request 1802 more closely matches the declined applications 1812 than the pending applications 1814. In some embodiments, recruiter reminder 1804 may deny request 1808 if the job seeker 502 does not more closely match the interacted with applications 1816 than the pending applications 1814. In some embodiments, the recruiter reminder 1804 will use a multi-varied analysis based on variables that have been shown to be important to the job poster 330.

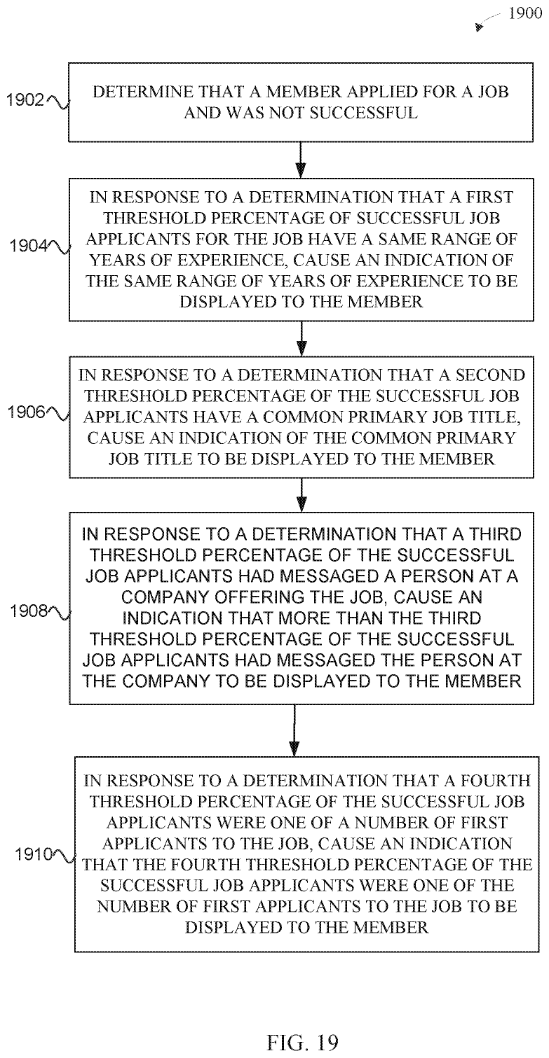

FIG. 19 illustrates a method for improving member user interaction 1900, in accordance with some embodiments. The method 1900 may begin at operation 1902 with determining that a member applied for a job and was not successful. For example, triggering events 702 may include an event 706 (e.g., first no response time 704, second no response time 706, etc.) that indicates that a job seeker 502 applied to a job 326 and was not successful. Job seeker interactions 902 may determine that the event 706 conditions are met.

The method 1900 may continue at operation 1904 with in response to a determination that a first threshold percentage of successful job applicants for the job have a same range of years of experience, causing an indication of the same range of years of experience to be displayed to the member. For example, job seeker interactions 902 may determine that a first threshold percentage of successful job applicants for the job have a same range of years of experience and display messages 1130 and 1132 as disclosed in conjunction with FIG. 11.

The method 1900 may continue at operation 1906 with in response to a determination that a second threshold percentage of the successful job applicants have a common primary job title, causing an indication of the common primary job title to be displayed to the member. For example, job seeker interactions 902 may determine that a second threshold percentage of the successful job applicants have a common primary job title and display messages 1134 and 1136 as disclosed in conjunction with FIG. 11.

The method 1900 may continue at operation 1908 in response to a determination that a third threshold percentage of the successful job applicants had messaged a person at a company offering the job, causing an indication that more than the third threshold percentage of the successful job applicants had messaged the person at the company to be displayed to the member. For example, job seeker interactions 902 may determine that a third threshold percentage of the successful job applicants had messaged a person at a company offering the job and display message 1142 as disclosed in conjunction with FIG. 11.

The method 1900 may continue at operation 1910 with in response to a determination that a fourth threshold percentage of the successful job applicants were one of a number of first applicants to the job, causing an indication that the fourth threshold percentage of the successful job applicants were one of the number of first applicants to the job to be displayed to the member. For example, job seeker interactions 902 may determine that a a fourth threshold percentage of the successful job applicants were one of a number of first applicants to the job and display message 1144 as disclosed in conjunction with FIG. 11.

Method 1900 may include one or more additional operations. The operations of method 1900 may be performed in a different order. One or more of the operations of method 1900 may be optional. Method 1900 may be performed by machine 2100.

FIG. 20 illustrates a method for improving member user interaction 2000, in accordance with some embodiments. The method 2000 begins at operation 2002 with determining that a first member that applied for a job is an unsuccessful job applicant when the first member has not received a first contact from a second member associated with a job posting of the job. For example, member 802 may have applied to a job 326 and not have received a member profile 804 view or a message from a member associated with the job posting 302, e.g., company 402 or recruiters 602. For example, text 1024 illustrates no views for job 1026.

The method 2000 may continue at operation 2004 with determining that third members that applied to the job are successful job applicants when the third members received second contacts from the second member. For example, a member 802 may be determined to be a successful job applicant if the member 802 receives a member profile 804 view (e.g., as indicated at 1615). In other examples, the member 802 may be determined to be a successful job applicant if the member 802 is offered or accepts the job 326 and/or if the member 802 is messaged by a person, e.g., poster 330 or recruiter 602, associated with the job 326.

The method 2000 may continue at operation 2006 with determining attributes of the third members (e.g., the successful members). For example, job seeker interactions 902 may determine attributes of successful job applicants, e.g., job seeker interactions 902 may determine that a threshold percentage of the successful job applicants have a common primary job title and display messages 1134 and 1136 as disclosed in conjunction with FIG. 11. Other attributes may be determined, e.g., as disclosed in conjunction with FIG. 19.

The method 2000 may continue at operation 2008 with causing an indication of at least one attribute of the attributes to be displayed to the first member. For example, continuing the example above, the display message 1134 and 1136 of FIG. 11 display the job title. Other attributes may be displayed as disclosed in conjunction with FIG. 19.

The method 2000 may continue at operation 2006 with causing the list of other members to be displayed to the first member, where the list includes a list of links that initiates messaging to a corresponding member of the list of other members. For example, referring to FIG. 10, members 1030, 1032, and 1034 may be displayed with message 1031, 1033, 1035, being configured to initiate messaging to a corresponding member 1030, 1032, 1034, when selected.

In some embodiment method 2000 may, optionally, include in response to a determination that the job is still open, determining a list of other members that are employed at a company offering the job, where the list of other members is determined based on whether the first member is connected to the other members within a connection network. For example, job seeker interactions 902 may determine a list of other members (e.g., referring to FIG. 10, the list of members 1028 includes members 1030, 1032, and 1034) that are employed by the company (e.g., “Company Y”) and that are connected to the member 802 within the connection network system 100 (e.g., using connection graph data 118).

The method 2000 may continue, optionally, with causing the list of other members to be displayed to the first member, where the list includes a list of links that initiates messaging to a corresponding member of the list of other members. For example, referring to FIG. 10, members 1030, 1032, and 1034 may be displayed with message 1031, 1033, 1035, being configured to initiate messaging to a corresponding member 1030, 1032, 1034, when selected.

Method 2000 may include one or more additional operations. The operations of method 2000 may be performed in a different order. One or more of the operations of method 2000 may be optional. Method 2000 may be performed by the machine 2100.

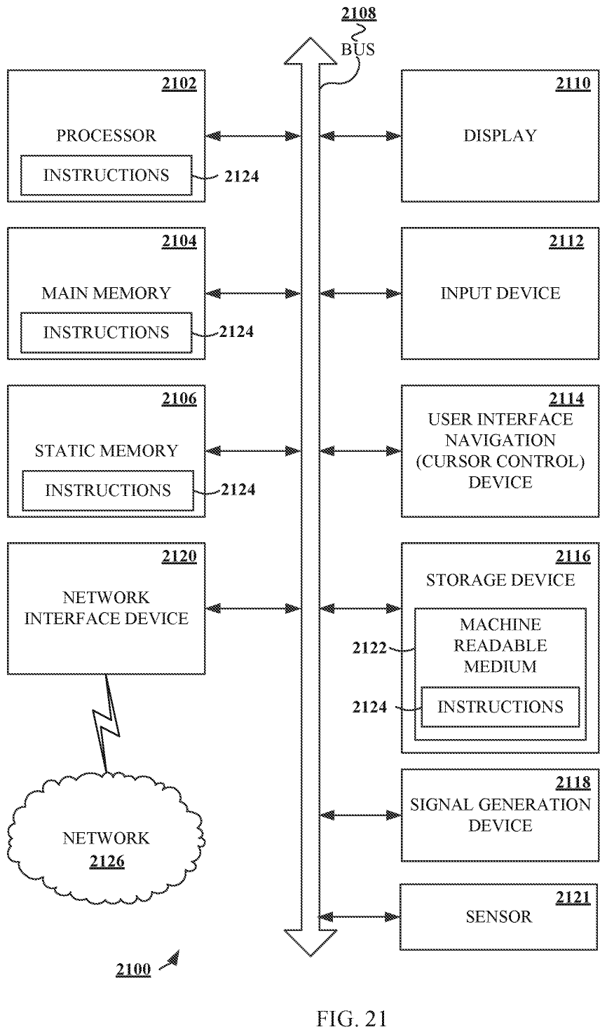

FIG. 21 shows a diagrammatic representation of the machine 2100 in the example form of a computer system and within which instructions 2124 (e.g., software) for causing the machine 2100 to perform any one or more of the methodologies discussed herein may be executed. In alternative embodiments, the machine 2100 operates as a standalone device or may, be connected (e.g., networked) to other machines. In a networked deployment, the machine 2100 may operate in the capacity of a server machine or a client machine in a server-client network environment, or as a peer machine in a peer-to-peer (or distributed) network environment. The machine 2100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 2124, sequentially or otherwise, that specify actions to be taken by that machine. Further, while only a single machine is illustrated, the term “machine” shall also be taken to include a collection of machines that individually or jointly execute the instructions 2124 to perform any one or more of the methodologies discussed herein.

The machine 2100 includes a processor 2102 (e.g., a central processing unit (CPU), a graphics processing unit (GPU), a digital signal processor (DSP), an application specific integrated circuit (ASIC), a radio-frequency integrated circuit (RTIC), or any suitable combination thereof), a main memory 2104, and a static memory 2106, which are configured to communicate with each other via a bus 2108. The machine 2100 may further include a graphics display 2110 (e.g., a plasma display panel (PDP), a light emitting diode (LED) display, a liquid crystal display (LCD), a projector, or a cathode ray tube (CRT)). The machine 2100 may also include an alphanumeric input device 2112 (e.g., a keyboard), a user interface navigation (cursor control) device 2114 (e.g., a mouse, a touchpad, a trackball, a joystick, a motion sensor, or other pointing instrument), a storage unit 2116, a signal generation device 2118 (e.g., a speaker), and a network interface device 2120.

The storage unit 2116 includes a machine-readable medium 2122 on which is stored the instructions 2124 (e.g., software) embodying any one or more of the methodologies or functions described herein. The instructions 2124 may also reside, completely or at least partially, within the main memory 2104, within the processor 2102 (e.g., within the processor's cache memory), or both, during execution thereof by the machine 2100. Accordingly, the main memory 2104 and the processor 2102 may be considered as machine-readable media. The instructions 2124 may be transmitted or received over a network 2126 via the network interface device 2120.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 2122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 2100), such that the instructions, when executed by one or more processors of the machine (e.g., processor 2102), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method, the method comprising:
determining, by at least one hardware processor, that a first member that applied for a job is an unsuccessful job applicant when the first member has not received a first contact from a second member associated with a job posting of the job;
determining, by at least one hardware processor, that third members that applied to the job are successful job applicants when the third members received second contacts from the second member;
determining attributes of the third members; and
causing, by at least one hardware processor, an indication of at least one attribute of the attributes to be displayed to the first member.

2. The computer-implemented method of claim 1, wherein the computer-implemented method further comprises:
in response to a determination, by at least one hardware processor, that at least a threshold percentage of the successful job applicants for the job have a same range of years of experience, causing an indication of the same range of years of experience to be displayed to the first member, wherein the threshold percentage is a value from 25 percent through 100 percent.

3. The computer-implemented method of claim 1, wherein the second member is a recruiter of the job or an employer of the job, wherein the first contact is a message from the second member to the first member or a profile view of the first member by the second member, and wherein the second contacts are messages from the second member to the third members or a profile view of a third member of the third members by the second member.

4. The computer-implemented method of claim 1, wherein the method further comprises:
in response to a determination that the job is still open, determining, by at least one hardware processor, a list of other members that are employed at a company offering the job, wherein the list of other members is determined based on whether the first member is connected to the other members within a connection network; and
causing, by at least one hardware processor, the list of other members to be displayed to the first member, wherein the list of other members includes a list of links that initiates messaging to a corresponding member of the list of other members.

5. The computer-implemented method of claim 1, wherein the computer-implemented method further comprises:
in response to a determination, by at least one hardware processor, that at least a threshold percentage of the successful job applicants have a common primary job title, causing an indication of the common primary job title to be displayed to the first member, wherein the threshold percentage is a value from 10 percent through 50 percent.

6. The computer-implemented method of claim 1, wherein the computer-implemented method further comprises:
in response to a determination, by at least one hardware processor, that at least a threshold percentage of the successful job applicants had messaged a person at a company offering the job, causing an indication that more than the threshold percentage of the successful job applicants had messaged the person at the company to be displayed to the first member.

7. The computer-implemented method of claim 6, wherein the person is not associated with the job posting of the job.

8. The computer-implemented method of claim 1, wherein the computer-implemented method further comprises:
in response to a determination, by at least one hardware processor, that at least a threshold percentage of the successful job applicants were one of a number of first applicants to the job, causing an indication that the threshold percentage of the successful job applicants were one of the number of first applicants to the job to be displayed to the first member.

9. The computer-implemented method of claim 1, wherein the method further comprises:
determining, by at least one hardware processor, a field of study for each of the successful job applicants; and
in response to a determination, by at least one hardware processor, that at least a threshold percentage of the successful job applicants had a same field of study, causing, by at least one hardware processor, an indication of the field of study to be displayed to the first member.

10. The computer-implemented method of claim 1, wherein the method further comprises:
determining, by at least one hardware processor, a primary job for each of the successful job applicants;
determining, by at least one hardware processor, for each of the successful job applicants a primary job title by matching a job title of the primary job of the successful job applicant of the successful job applicants to a database of standard primary job titles; and
in response to a determination, by at least one hardware processor, that at least a threshold percentage of the successful job applicants had a same primary job title, causing, by at least one hardware processor, an indication of the same primary job title to be displayed to the first member.

11. The computer-implemented method of claim 1, wherein the method further comprises:
determining, by at least one hardware processor, that the first member saved a second job; and
in response to a determination that the second job has more than a threshold number of applicants in less than a threshold number of days, causing, by at least one hardware processor, an indication that the second job has more than the threshold number of applicants in less than the number of days to be displayed to the member.

12. The computer-implemented method of claim 1, wherein the method further comprises:
determining, by at least one hardware processor, a list of other members with matching profile fields as the first member;
determining, by at least one hardware processor, a list of first other jobs with matching descriptions to second other jobs, wherein the second other members were successful applicants to the second other jobs, and wherein the first other jobs are open jobs and the second other jobs are closed jobs; and
causing, by at least one hardware processor, an indication of the list of first other jobs to be displayed to the first member.

13. The computer-implemented method of claim 1, wherein the method further comprises:
determining, by at least one hardware processor, that the first member saved a second job; and
in response to a determination that the second job has fewer than a threshold number of applicants, causing, by at least one hardware processor, an indication that the second job has fewer than the threshold number of applicants to be displayed to the first member.

14. A system comprising:
a machine-readable medium storing computer-executable instructions; and
at least one hardware processor communicatively coupled to the machine-readable medium that, when the computer-executable instructions are executed, the at least one hardware processor is configured to:
determine, by at least one hardware processor, that a first member that applied for a job is an unsuccessful job applicant when the first member has not received a first contact from a second member associated with a job posting of the job;
determine, by at least one hardware processor, that third members that applied to the job are successful job applicants when the third members received second contacts from the second member;
determine attributes of the third members; and
cause, by at least one hardware processor, an indication of at least one attribute of the attributes to be displayed to the first member.

15. The system of claim 14, wherein the at least one hardware processor is further configured to:
in response to a determination, by at least one hardware processor, that at least a threshold percentage of the successful job applicants for the job have a same range of years of experience, cause an indication of the same range of years of experience to be displayed to the first member, wherein the threshold is a value from 25 percent through 100 percent.

16. The system of claim 14, wherein the second member is a recruiter of the job or an employer of the job, wherein the first contact is a message from the second member or a profile view of the first member by the second member, and wherein the second contacts are messages from the second member to the third members or a profile view of a third member of the third members by the second member.

17. A machine-readable medium storing computer-executable instructions stored thereon that, when executed by at least one hardware processor, cause the at least one hardware processor to perform a plurality of operations, the operations comprising:
determine, by at least one hardware processor, that a first member that applied for a job is an unsuccessful job applicant when the first member has not received a first contact from a second member associated with a job posting of the job;
determine, by at least one hardware processor, that third members that applied to the job are successful job applicants when the third members received second contacts from the second member;
determine attributes of the third members; and
cause, by at least one hardware processor, an indication of at least one attribute of the attributes to be displayed to the first member.

18. The machine-readable medium of claim 17, wherein the plurality of operations further comprise:
in response to a determination, by at least one hardware processor, that at least a threshold percentage of the successful job applicants for the job have a same range of years of experience, causing an indication of the same range of years of experience to be displayed to the first member, wherein the threshold is a value from 25 percent through 100 percent.

19. The machine-readable medium of claim 17, wherein the second member is a recruiter of the job or an employer of the job, wherein the first contact is a message from the second member or a profile view of the first member by the second member, and wherein the second contacts are messages from the second member to the third members or a profile view of a third member of the third members by the second member.

20. The machine-readable medium of claim 17, wherein the plurality of operations further comprise:
determining, by at least one hardware processor, a list of second other members with matching profile fields as the first member;
determining, by at least one hardware processor, a list of first other jobs with matching descriptions to second other jobs, wherein the second other members were successful applicants to the second other jobs, and wherein the first other jobs are open jobs and the second other jobs are closed jobs; and
causing, by at least one hardware processor, an indication of the list of first other jobs to be displayed to the first member.
